(19) United States
(12) Patent Application Publication
(10) Pub. No.: US 2009/0274936 A1
(43) Pub. Date: Nov. 5, 2009

(54) CARBON MONOXIDE CATALYST SYSTEM TO REMOVE CO

(76) Inventors: Mark K. Goldstein, Del Mar, CA (US); Michelle Sunly Oum, Chula Vista, CA (US)

Correspondence Address: CHRISTIE, PARKER & HALE, LLP, PO BOX 7068, PASADENA, CA, 91109-7068, US

(21) Appl. No.: 12/304,268

(22) PCT Filed: Jun. 6, 2006
(86) PCT No.: PCT/US06/22181

§ 371 Date: Jun. 30, 2009

(51) Int. Cl. B01D 53/34; B01J 31/02; B01D 53/58; B01D 53/62; H01M 8/02

(52) U.S. Cl. 429/13; 422/122; 502/159; 422/177; 423/247; 423/237

(57) ABSTRACT

The present invention provides an apparatus and method for removing CO gas from gas streams or static air. One application of interest in removing CO from air to provide clean air to breathe or other application such as CO monitoring instruments for calibration, to the air side of the fuel cell and to the reformate stream that is employed for a PEM fuel cell. This invention protects the fuel cell catalyst by a means to controlling CO in the reformate stream. The control system is designed to minimize the CO concentration using the novel CO oxidation catalysts described above. One preferred embodiment catalyzes and monitors the CO to indicate the effectiveness; and further comprising two alternate chambers containing catalyst, which is made of high surface area substrate with supramolecular chemistry coated onto that substrate. These supramolecular catalyst converts CO gas to CO2 and at least one CO sensor monitors each catalyst chamber and control the process to maximize the fuel cell efficiency or to trigger a signal for service. Many other applications to reduce CO in static air as well as in gas stream are feasible including ultra zero air for CO measuring instruments, diving air, ultra-high purity laboratory air and air cleaners and air purifiers designed to reduce health impact to people in homes, hotels, health facilities, transportation systems, workplaces and in other enclosed structures.

### TECHNICAL FIELD

This invention describes an important and novel means to selectively convert CO to CO2 in air and hydrogen rich gas streams without substantial loss or conversion of hydrogen to water. These novel catalysts comprise organometallic supramolecular complexes. One important application is to control CO in gas streams for use in Proton Exchange Membrane (PEM) fuel cells and other fuel cells. Most fuel cell operate between 180° C. and 300° C. with the fuel cell operating at 60° C. to 85° C. Therefore, it is convenient to operate the catalyst bed before the fuel cell near 60° C. to 85° C. Therefore a low temperature operating catalyst such as 10K catalysts are very useful and can be manufactured with low cost plastics.

The catalytic control system converts CO to CO₂ and therefore the bed can be used to increase the efficiency of the fuel cell system by minimizing the CO poisoning of the fuel cells and controlling pollutant emissions. Of particular interest is an improvement in automotive Carbon Monoxide Detection and Purification (CODAP) systems. These CODAP systems may be incorporated into most any fuel cell systems that use hydrocarbon reformers using the technology and invention described herein.

Currently, there are vehicles under development by Mercedes Benz, Ford, General Motors, United Technology Corporation and others that use reformers to convert hydrogen rich materials into hydrogen. Using a catalyst that converts low levels of CO to CO₂ prevents fuel cell catalyst poisoning (the fuel cell active anode catalyst component is primarily platinum). Further, this CODAP system includes means for reducing the CO concentration in the reformer by changing operating parameters through a feedback circuit and/or by using partial oxidation catalytic means to convert the CO to CO2. However, the system generally cannot economically reduce CO below 10 PPM. Therefore, there is a need for a catalyst that can reduce CO in concentrations from about 2000 to less than 10 ppm and from about 10,000 ppm to below 300 ppm. A new series of selective oxidation catalysts have been developed. They are the only catalysts that have been demonstrated to operate in an oxygen free hydrogen rich environment without consuming hydrogen. These catalysts are referred to as 10K, 5Y, 21B, and 81E catalysts. These catalysts work well when oxygen is present in the gas, such as for air purification. Alternatively, the oxygen may be cycled in and out of a near oxygen free environment for fuel cell and other applications.

Furthermore, the CO detection and purification (CODAP) system may warn the driver of a CO problem by audible or visible alerts to allow him time to get to a service station. The presence of moderate amounts of excess CO reduces efficiency. However, higher concentrations of CO can shut down the fuel cell power system. In addition, the information about the concentration and rate of change of concentration of CO may be used to control the partial oxidation processes as well as other reformer process parameters. The presence of higher CO levels can endanger all occupants, reduce fuel efficiency and pollute the environment. Should the CO levels become high enough, it can kill passengers and other people. If there is a leak in the reformer stream, a CO monitoring device in the cabin can warn the occupants. The warning may be visible and/or audible, such as a sound device or even the horn. If necessary, the alarm can shut off the reformer process to protect human lives. The near infrared CO sensing system using Quantum Group Inc.'s K series sensors may be used in place of other sensing system such as expensive infrared (1R) and electrochemical instruments.

One type of CO sensor is a solid state near infrared monitored system, which may be based on an optically responding material, e.g. a biomimetic or K series sensor. The present invention improves the sensing options by using K or Q sensor formulations and systems. Many of these types of sensors require oxygen for regeneration. The detector portion can be separated into at least two components, one for sensing and the other for regeneration at any given time. The biomimetic CO sensors can be used with low cost optical monitoring systems for systems having very low concentrations of hydrogen, e.g., with an LED and photodiode. However, the Q2.COM system uses the K series sensors which do not react with hydrogen. Therefore, these K sensors are useful for fuel cell applications in combination with catalysts. In addition, the Q2.COM system may be configured to effectively compensate for the changes in RH in the gas stream although most PEM fuel cells control RH making such compensation unnecessary.

The sensor may be part of a control system to provide feedback information to the main control of the reformer. The CODAP system may add functions within the vehicle including one or more purification systems to remove CO from the hydrogen rich reformate, ambient air in the fuel line and/or passenger compartment. In addition, means for alerting people to the CODAP system may include CO hazard in the cabin, the need for service and/or the need to shut down the fuel cell reformer system in case of a CO leak or a failure of any kind that leads to high CO levels. The fuel cells may be used in homes, appliances (such as computers and cell phones), businesses, communities, and vehicles.

In air purification applications, the catalyst may be used in a static systems or in air flow systems. The catalyst may be optimized for any specific application to reduce cost by increasing surface area and reducing precious metal content. The surface area can be increased by using small beads, for example beads having diameters ranging from about 1 to 100 microns, surface areas ranging from about 100 to 1000 grams per meter, and average pore sizes ranging from about 70 Angstroms to 300 Angstroms. In air purifiers, means for removing allergens, odors and other toxic gases may be included in the CO removal system.

### FIELD OF THE INVENTION

The present invention relates to a means for rapidly and economically removing CO from gas streams including air stream, hydrogen rich and other streams. One important application for such a catalyst is air purification. The air purification system may comprise a HEPA filter and activated carbon filter(s) as well as a CO removal system. Air purification systems may be static or flowing and, there is a need for activated carbon impregnated with an acid such as phosphoric acid, to surround the CO oxidation catalyst. The acid impregnated high surface carbon will remove basic gases and protect the catalyst. The prefilter and the HEPA filter will remove lint, dust and other allergens thereby protects the activated carbon and extending its life. Ammonia and other basic gases may get throw the prefilter and HEPA filter.

One important application of this invention is in fuel cell control systems protecting fuel cells using hydrocarbon reformers that may contain carbon monoxide (CO) in the hydrogen rich stream. The reformer system may include a fuel tank, a means to heat the fuel, a reactor for reacting the fuel with air and/or water. In some types of reformers, a partial oxidation catalyst (referred to as POX) is used. Others use steam reforming and/or autothermal reforming (water and air in the first step). In some reformers, a second reactor is provided in which water (usually from the fuel cell exhaust) is added in the presence of a water-shift catalyst. These treatment methods do not substantially reduce the CO below 2000 PPM and therefore a third stage is needed for that purpose. The third reactor system generally contains a noble metal in metallic form, which is not wholly selective and therefore consumes hydrogen.

Quantum Group Inc. has a novel selective oxidation catalyst to convert CO to CO2 without losing hydrogen. Currently, most CO oxidation catalysts convert about 3 to 6% of the hydrogen to water, which causes a loss in efficiency.

Fuel cells are well known energy conversion devices that are useful for vehicle propulsion, power plants and other power systems that use electricity. A variety of selective oxidation methods for removing CO have been developed to prevent poisoning of fuel cells. In PEM fuel cell systems, noble metals are used such as platinum, rhodium, palladium and alloys of platinum-ruthenium. Furthermore, metal oxides such as iron, vanadium, tungsten, cerium and magnesium have been used to promote selective oxidation.

The present invention converts the remaining levels of CO to CO₂ and senses the levels of CO without interference with hydrogen or CO₂. The chemistry of the inventive catalyst is similar to K series sensors. However, the supramolecular catalysts, such as 5Y, 21B and 81E perform significantly better (i.e., 5 to 15 times better) than K sensors.

These catalyst formulations with high copper concentrations have not been used to catalyze CO to CO₂ in hydrogen rich gas streams. The chemistry of these catalysts is similar to the sensor catalysts described in U.S. Pat. No. 6,172,759, issued Jan. 9, 2001 and entitled “Target gas detection system with rapidly regenerating optically responding sensors,” and U.S. Pat. No. 6,251,344 issued Jun. 26, 2001 and entitled “Air quality chamber: relative humidity and contamination controlled systems,” the entire contents of which are incorporated herein by reference. However, there are distinct differences in the chemical composition.

The inventive low temperature catalyst convert CO to CO2 at temperatures similar to those at which PEM fuel cells operate and the catalysts may be employed to reduce even low levels of CO from the air supply for a variety of applications. CO may be present in concentrations ranging from about 50 ppm to over 200 ppm in tunnels, factories, cities, mountain valleys, highways and other locations. In addition to removing CO from the hydrogen stream and to maintaining fuel cell efficiency, it is also desirable to substantially remove CO from the air intake system for most fuel cells whether or not they use a reformer. Therefore, this removal of CO from gases is a general novel embodiment of this invention that can be used to purify most gas streams that contain CO.

The CODAP system can detect and, with appropriate control circuitry, control the CO levels in the reformate stream to below 10 ppm if desired. The objective is to keep the CO level below a target amount (such as 300 ppm or 10 ppm) in the hydrogen rich reformate stream when entering the anode (hydrogen side) and the cathode (oxygen side) compartment of the fuel cell. Generally, the CO level should to be substantially lower than 100 PPM. This controlled reduction in CO in the hydrogen side can be accomplished by varying the air to fuel ratio in the reformer system, e.g. POX, autothermal or steam. Also, CO can be controlled by changing the temperature of the reformer reactors or by changing the water injection amount and temperature as well as other parameters. Increases in the water or steam input may be limited to the water produced by the fuel cell under normal operation conditions unless a water reservoir is refilled regularly or water is otherwise readily available. Fuel cells generate electricity by electrochemically combining hydrogen and oxygen without combustion. This low-temperature electric generation process is more efficient and produces less pollution than the combustion process.

The removal of CO is valuable in many systems. However, it is of special interest in reformer gas streams that feed PEM type fuel cells. Also of great interest is using the new and improved series of catalysts in air purification systems. These catalysts incorporate promoters to boost the efficiency of precious metals and in some cases reduce the amount of precious metals by as much as 50-75% while maintaining the same level of catalytic activity. These new catalysts are referred to as P series catalysts. The P series catalysts comprises sub-series such as 88H, 106A, 106B, 95B and 46A sub-series. These catalysts are desirable because they are less expensive (reduced precious metal), have lower weight, are simple to control and are more efficient than the previous 10K, 21B, 81E, and 5Y catalysts. Current reformer technology cannot control the CO under all conditions all the time. Therefore, the inventive catalysts are used to help remove CO as described below.

CO detection devices may be incorporated into a vehicle or other fuel cell system in a way to optimize the life and performance of the catalyst system and to optimize the efficiency of the fuel cell. This invention includes applications comprising one or more CO detector systems and feedback means to reduce CO from the reformer system. In addition, the CO removal system may include means for removing CO from the air-input side of the fuel cell as well as for removing CO from the air in the cabin of a vehicle or any other enclosed environment. Optionally, such a novel device can display information on the CO concentration before and after the use of the catalyst.

The present invention relates to CO removal systems such as for use in air purification, in fuel cell reformers for improving efficiency, in breather air tanks, and in instruments monitoring CO as a control or zero air applications.

Applications for CO purification include passenger cars, trucks, boats, aircraft and other vehicles, ships, power plants, homes, factories and other enclosed structures. In addition, purification of CO in hydrogen rich streams is desirable in many fuel cells. CO oxidation has historically been accomplished using high temperatures and precious metals such as platinum. For example, Hopcolite was developed to remove CO at room temperature, but only works when it is very dry, which makes it impractical for air purification and fuel cell applications. In addition, mixtures of salts containing palladium copper salts and molybdenum salts such as silicomolybdic acid has been used, which salts function at room temperature.

The CO removal catalyst system can further include a gas detection device, which can be used to determine the effectiveness of the catalyst and to control its use. Such gas detection devices may be used to monitor the time for replacing a component in the catalyst system or the time for switching from sensing and catalyzing of one catalyst bed to another such that one is catalyzing CO while the other is regenerating. The detection devices may be configured to send feedback information as a means to control the catalyst system. It can also shut off the CO source should there be a catastrophic failure in the system, or simply provide an audible and/or visible signal depending on the application.

The catalyst system should be able to detect and catalyze CO to CO₂ from natural gas, propane, methanol, diesel, gasoline and other fuel reformers for fuel cells. The CO levels entering the fuel cell at the hydrogen side should be reduced, but the catalysts systems can also be used to reduce CO on the oxygen side. Reducing CO at the anode is important because that is where the poisoning occurs.

The CO sensor can also be used to control the flow of a gas stream to either pass through a catalyst or not. One composition of an active sensor that has been shown to respond to CO in the presence of hydrogen is the K-sensor.

The concentration of copper (Cu) ions may be many times higher in the catalyst than in typical CO sensor formulations such as those described in U.S. Pat. Nos. 5,618,493 and 5,063,164, the entire contents of which are incorporated herein by reference. It is believed that electrons transfer from Pd to Mo in the biomimetic CO sensors. This process can be reversed if oxygen is present in sufficient quantity, but not in hydrogen rich streams that contain very small amounts of oxidizer, such as oxygen. To prevent hydrogen from reducing the Pd ions to Pd metal in the presence of hydrogen over long periods of time, several methods may be employed as described below.

First, the copper ion concentration can be 5-15 times more than the palladium ion concentration. Second, the pH of the catalyst coating formulation may be varied to optimize its catalytic performance in air or hydrogen rich streams. Third, calcium chloride and bromide ions may be partially or completely replaced with other ions such as cadmium, nickel, cerium, chromium, magnesium, iron, manganese, strontium and zinc halides as well as rare earth ions or mixtures thereof and mixtures of rare earths and trans metal ion catalysts. The temperature and humidity of the system may be controlled, which can improve catalytic performance. One advantage of this system over palladium nano particles is that it oxidizes CO to CO₂ under dry and wet conditions.

Furthermore, in fuel cell system applications, more than one catalyst bed may be employed such that when one bed gets reduced, it is then exposed to air and the second bed is then used to treat the gas stream. The chemistry of the catalyst may not visually change its color in an air environment; however, it may change its color if left far too long in an oxygen free environment high CO concentrations.

One embodiment of the invention comprises a dual catalyst system (“DSC”) in which a control system multiple catalyst tubes or beds and a valve system to allow the control of air and reformate to alternate to ensure that at least one catalyst is always converting the CO to CO₂. The DSC converts CO to CO₂ in the hydrogen stream effectively, and at least one DSC bed is being regenerated by the air stream. Two or more CO sensing disks are monitored, one in the hydrogen stream and at least one in the air. When the first sensing disk in the stream nears saturation (e.g., when catalytic oxidation is used up) in response to CO, the valve system is actuated. The valve system actuation causes the second sensing disk to be exposed to CO in the hydrogen rich gas stream and the first sensing disk to be exposed to air at about the same time. The CODAP system optionally includes a means for reducing the CO levels in the reformate stream by one or more control means as well as two catalyst beds.

The information from the sensing system may be used to control the reform parameters and/or the partial oxidation catalytic reformer as well as the DCS for hydrogen rich streams. For the system to be used in air, only one catalyst bed is needed. Such systems this include the oxygen end of a fuel cell system, cabin air intakes and other air intakes where CO is a concern.

The catalyst chemistry may be adjusted from that of the K sensor to other chemistries as described above. The catalyst is normally applied to a porous substrate such as silica by a self-assembly process. The porous silica usually has a pore diameter ranging from about 4 nm to 40 about nm (40 to 400 Angstroms). These porous substrates may be fabricated by a number of processes similar to those used for the K sensor and the biomimetic sensors. The porous substrate may range from about 1 micron to about 5 mm in particle size. The substrates are coated with a supramolecular catalyst material, which is believed to be applied by a self-assembly process resulting in a thin layer of catalyst. The reaction rate of the catalytic activity is proportional to the CO concentration, and also depends on the relative humidity, temperature, pressure and oxygen concentration as well as the surface area and chemistry of the catalyst. The catalyst is rapidly regenerated when exposed to air. Thus, the alternating sensing/regenerating cycle allows smooth and efficient operation of the fuel cell reformer systems.

The present invention involves improved chemical catalysts, which use porous substrates such as silicon dioxide, aluminum and boron containing silicon dioxide, oxides; mixed oxides, coated oxides and mixture thereof. More opaque substrates such as silicon dioxide having larger pore diameters may also be employed for catalyst applications. Silicon dioxide gradually becomes white and opaque at pore diameters above about 30 nm to 50 nm (300 to 500 Angstroms).

Exemplary catalysts have the following characteristics: 1) They contain mixed metal oxides as promoters; 2) They contain less precious metals; 3) They are more efficient; 4) they contain phosphomolybdic acid, sodium vanadate, sodium tungstate, or any mixture thereof in place of and/or in addition to molybdosilicic acid and 5) they contain much higher copper concentrations.

Like the sensor and catalyst formulations disclosed in U.S. Pat. No. 5,063,164, 5,618,493, the co-pending U.S. patent application Ser. No. 11/058,32, filed Feb. 4, 2005, the newly innovated oxidation catalysts also 1) selectively converts CO to CO₂ upon contact with CO; 2) self-regenerate in air; 3) consume no hydrogen; 4) require no power to convert CO to CO₂; 5) have long functional life; 6) become more efficient in the subsequent exposures to CO. Like the previous catalyst and the biomimetic sensor formulations, these newly formulations are made by what is believed to be a self-assembly coating of reagents onto solid porous, transparent, semi-transparent or opaque substrates. These porous high surface area substrates can be fabricated in any number of ways such as standard ceramic methods or sol-gel methods. The materials of choice include but are not limited to silicon dioxide, aluminum silicon dioxide and other metal and mixed metal oxides, ceramics such as Cordierite, yttrium oxide and aluminum oxide containing or mixtures thereof.

Mixing reagents, are similar to the newly formulated CO oxidation catalysts, except there are ions of cadmium, zinc or nickel place of and/or in addition to calcium ions in the exemplary catalyst. To U.S. Pat. No. 5,618,493 is added in various ratios of very high concentrations of copper ions with the appropriate ratio of anions, and then coated onto porous solid substrates. In addition, the calcium chloride may be substituted either in whole or in part using a mixture of other chlorides such as cadmium chloride and bromide, as well as iron, nickel, cobalt, zinc and aluminum or mixtures thereof.

The CO catalyst reagents contain at least one of chemical substance from the following groups:

Group 1: Palladium salts selected from the group consisting of PdBr₂, PdCl₂ CaPdCl₄, CaPdBr₄, Na₂PdCl₄, Na₂PdBr₄, K₂PdCl₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof;

Group 2: Molybdenum salts selected from the group consisting of silicomolybdic acid, phosphomolybdic acids, phosphotungstic acid, silicotungstic acid, ammonium molybdate, ortho-sodium vanadates (e.g., Na₃VO₄), meta-sodium vanadate (e.g., NaVO₃), lithium molybdate, sodium molybdate, cobalt molybdate, sodium tungstate, bismuth molybdate, and mixtures of any portion or all of the above;

Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof;

Group 4: Supramolecular complexing molecules selected from the cyclodextrin family including beta, gamma, as well as their soluble derivatives such as hydroxypropyl beta cyclodextrin and other derivatives and mixtures thereof;

Group 5: Chloride and bromide salts of Al, Ca, Cd, Sr, Mg, Ce, Co, Ir, Mn, Ni, Cr, Zn, Dy, Gd, Fe, Sm, and any mixtures thereof.

Group 6: Organic solvent and/or co-solvent trichloroacetic acid;

Group 7: Soluble inorganic acids such as hydrochloric acid and nitric acid

Group 8: Strong oxidizer such as peroxide

The mole ratio ranges for the chemical components of the catalyst reagents used to make the newly innovated P catalyst series vary as follows depending on the catalyst reagents, some contain at least one chemical from each of group 1 to group 8 and some contain at least one chemical from group 1 to group 6.

Mole Ratios for catalyst reagent containing at least one chemical from group 1 to group 8 are shown below.

| | |
|---|---|
| Group 1 | Group 2 = 1.78:1 to 8.00:1 |
| Group 3 | Group 2 = 3.86:1 to 17.38:1 |
| Group 4 | Group 2 = 0.02:1 to 0.58:1 |
| Group 5 | Group 2 = 3.98:1 to 17.99:1 |
| Group 6 | Group 2 = 0.01:1 to 0.02:1 |
| Group 7 | Group 2 = 0.10:1 to 3.00:1 |
| Group 8 | Group 2 = 0.10:1 to 3.00:1 |

Mole Ratios for catalyst reagent containing at least one chemical from group 1 to group 6 are shown below.

| | |
|---|---|
| Group 1 | Group 2 = 2.47:1 to 3.71:1 |
| Group 3 | Group 2 = 6.19:1 to 18.56:1 |
| Group 4 | Group 2 = 0.09:1 to 0.28:1 |
| Group 5 | Group 2 = 2.78:1 to 8.33:1 |
| Group 6 | Group 2 = 0.003:1 to 0.008:1 |

Note that these ratios are very different from those disclosed in the previous U.S. Pat. Nos. 5,063,164 and 5,618,493. However, the reagent mixtures for the new catalyst may be formulated by mixing the spent (by products or wastes) solutions from by adding the additional copper ions to the spent solutions. It is very economical when by products from one product can be made into another useful product such as a catalyst for converting CO to CO₂, especially in fuel cell related applications.

The porous, high porosity substrates with uniform pore diameters ranging from 100 to 300 angstroms or 10 to 30 nm, into which the chemical reagents are incorporated, selected from any of the following substrate groups:

Substrate 1: Porous silica gel such as in bead form, which is available from most many suppliers of silica gel or porous silicon dioxide give example of spec and supplier 150 Angstroms (15 nm) and surface area of 250 m/gram, this material is supplied by Chem Source East, Inc. 7865 Quarterfield Road Severn, Md. 21144, Telephone No. 410-969-3390. (Silica Gel Bead, Grade TS-1, 1.0 to 2.0 mm, 1.0 to 3.0 mm, or 2.0 to 5.0 mm particle size, 110 to 130 angstroms pore diameter, 340 to 400 m2/gram surface area, and 0.9 to 1.1 cc/g pore volume).

Substrate 2: Commercially available porous, leached borosilicate glass such as VYCOR (“THIRSTY GLASS”, Corning Glass Works, Corning, N.Y. Brand No. 7930), which has been processed to increase the pore diameter with ammonium bi-fluoride treatment. The porous glass may be available in plate, rod, or tubing form, which can be sliced into suitable shapes and dimensions.

Substrate 3: Other certain porous metal oxides that are not soluble or do not react with any of the chemical reagents described in-groups 1 through 8 such as porous silica, doped silicon dioxide, aluminum oxide, yttria and yttria aluminum garnet (YAG) and mixtures thereof.

Substrate 4: Other methods of preparing the porous solid include growth by any suitable sol-gel method. Tetraethyl orthosilicate (TEOS) or Tetramethyl orthosilicate (TMOS) may be used to form silicic acid by adding water and a catalyst such as formamide and HCl, gelling and aging, which can then be converted to a the xero-gel upon firing to above 600° C.

Substrate 5: A high purity porous silica gel having uniform pore diameters, which are manufactured using U.S. Pat. No. 4,059,658 and several modifications thereof and doped with mixed oxides.

Substrate 6: Cordierite may be dip coated into a porous silica using Quantum Group Inc.'s standard SPS mixture, which was disclosed in the K series sensor patent (are mixture of colloidal silica and potassium silica and formamide) to form a porous silica with 25 nm pores. The material is leached with ammonium nitrate, water or water with colloidal silica to reduce the potassium levels to below 200 PPM. The SPS may be made by mixing according to U.S. Pat. No. 4,059,658 (Robert Shoup) except leaching is limited to a potassium level of over 100 PPM but less than 200 PPM. The SPS may be applied to Cordierite by a simple dip coating.

Substrate 7: Porous silica powder with particles sizes ranges from 1 to 500 microns with pore sizes ranges from 50 to 200 Angstroms (5 to 20 nm) and surface area of 250 to 1,000 m/gram. Such material can be made by crushing porous silica gel or beads such as that supplied by Source-East, Inc. 7865 Quarterfield Road Severn, Md. 21144, Telephone No. 410-969-3390. (Silica Gel Bead, Grade TS-1, 1.0 to 2.0 mm, 1.0 to 3.0 mm, or 2.0 to 5.0 mm particle size, 110 to 130 angstroms pore diameter, 340 to 400 m2/gram surface area, and 0.9 to 1.1 cc/g pore volume). Further grinding significantly increase the surface area and shorten the gas diffusion path.

Pre-surface modification such as metal oxide/mixed metal oxide coating to any of substrates 1-2, and 4-7 above, has been shown to significantly improve CO oxidation given the same level of previous metal ions loading such as that of Pd. The metal oxide/mixed oxides behave as promoters in enhancing the catalyst activities. Mixed oxides also provide enhanced hydrogen bonding, which supplies protons necessary for the CO oxidation when amount of water in the air is extremely low as in the case of low relative humidity of below 30%. The starting materials for forming these oxides are shown below in Substrates 9-10.

Substrate 9: Surface modification onto any of the substrates listed under substrates 1-2, and 4-7 above by coating them with nitrate salts of Cu, Cr, Co, Pr, Sm, Sc, Y, Tm, Zn, Yb, Ni, Nd, Ho, Ce, Dy, Gd, La, Er, Sn, Zn, and/or any mixture thereof, and firing them at 400-500° C. to form metal oxide and mixed metal oxides on silicon oxide based substrates. The mixed oxide surfaces function as promoter to boost the efficiency of the precious metals.

Substrate 10: Surface modification onto any of the substrates listed in substrates 1-2, and 4-7 above by coating them with alkoxy and/or acetate complexes of Cu, Cr, Co, Pr, Sm, Sc, Y, Tm, Zn, Yb, Ni, Nd, Ho, Ce, Dy, Gd, La, Er, , Sn, Zn, and/or any mixture thereof, and firing them at 400-500° C. to form metal oxide and mixed metal oxides on silicon oxide based substrates. The mixed oxide surfaces function as promoter to boost the efficiency of the precious metals.

Substrate 11: Surface modification onto any of the substrates listed in substrates 1-2, and 4-7 above by coating them with Au, colloidal Au, HAuC14, Au(OH)₃, and fire them at 400-500° C.

Substrate geometry is another key parameter in geometric configuration. The monolithic type substrate in open channel structures will require much less backpressure. In the case where backpressure is not important the success of a substrate may include its mesh sizes as well as its pore size. Larger pores reduce diffusion time but have less surface area. The present invention also utilizes porous silica substrate, which are also by products or wastes from a production of CO sensor for residential and commercial applications. They substrates are rejects from the CO sensor production due to mechanical break down such as chips and cracks, pore diameter, contaminate and surface area. Some of these substrate rejects are satisfactory for making CO catalyst. Commercially available substrates such as those porous silica beads and silica powder from Grace, ChemSource, and a few others are also good supports for the various improved catalyst coating reagents shown in the examples below.

In general Quantum Group, Inc.'s CO removal catalysts comprised of 1) silica/SiO₂ based substrates, which may or may not be further coated with a single or a combination of metal oxides as promoters (Substrates 1-11), 2) single and/or multiple coatings of catalyst reagents (combination mixtures of at least one chemical substance from the above Groups 1 to 8 to give catalyst reagents such as 5Y, 5NaV, 5Mn, 5Cd, and 5PMA.

The newly innovated catalysts based on the above combinations are referred to as the P series and are typically synthesized by coating the silica substrates with 1.0 to 1.5 M stock solution of a nitrate salt and/or acetate compound of copper alone and/or plus 0.05 M to 0.225 M stock solution of nitrate salt and/or acetate compound of Ce, Ce, Cr, Co, Dy, Er, Gd, Ho, La, Nd, Pr, Sm, Sc, Tm, Yb, Y, Zn, and/or any combination thereof. The mixture is fired to form layers of mixed metal oxides on surface of the silica substrates. (The mixed oxides layers function to increase the efficiency of palladium. Certain metal oxides such as those of chromium and samarium provide a good network of hydrogen bonding. Hydrogen from water vapor provides a good source of protons, which are important in CO oxidation reactions). Next a single and/or multiple coatings of catalyst reagents such as 5Y, 5NaV, 5Mn, 5Cd, 5PMA, and/or any mixture combination thereof is applied to the mixed oxides coated substrate.

Examples below describe the newly innovated Quantum Group, Inc.'s CO removal catalysts for catalyzing CO to CO₂ in hydrogen rich stream for fuel cell applications and/or air purification applications.

### Example 1

The P-100F series catalyst is synthesized as follows: 115 ml of 0.5 M Cu (II) nitrate is added to 250 cc of porous silica beads (ChemSource Inc., Grade TS-1, 1.0 to 2.0 mm), mixed, and then fired at 400° C. for 36 hours. After allowing the system to equilibrate to ambient temperature and ambient relative humidity for 18 to 24 hours, 115 ml of a 5Y catalyst solution is added to the CuO coated porous silica bead, mixed, and then heated inside 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo1₂O₄₀ hydrate, 1.84E-05 mole of CCl₃COOH, 1.06E-06 mole of copper trifluoroacetyl-acetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 2

The P-112C series catalyst is synthesized as follows: 115 ml of a mixture of 0.5 M Cu (II) nitrate and 0.025 M Cr (III) nitrate is added to 250 cc of porous silica bead (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a 5Y catalyst solution is added to the CuO/Cr2O3-coated porous silica bead, mixed, and then heated at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo1₂O₄₀ hydrate, 1.84E-05 mole of CC13COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 3

The P-112A series catalyst is synthesized as follows: 115 ml of a mixture of 0.5 M Cu (II) nitrate and 0.025 M Ho(III) nitrate is added to 250 cc of porous silica bead (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a 5Y catalyst solution (Example 8 or 9) is added to the CuO/Ho₂O₃-coated porous silica bead, mixed, and then heated at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo1₂O₄₀ hydrate, 1.84E-05 mole of CCl3COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 4

The P-112B series catalyst is synthesized as follows: 115 ml of a mixture of 0.5 M Cu (II) nitrate and 0.025 M Nd (III) nitrate is added to 250 cc of porous silica bead (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a 5Y catalyst solution is added to the CuO/Nd₂O₃-coated porous silica bead, mixed, and then heated at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo1₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 5

The P-119B series catalyst is synthesized as follows: 115 ml of a mixture of 0.5 M Cu (II) nitrate and 0.025 M Sm (III) nitrate is added to 250 cc of porous silica bead (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a 5Y catalyst solution (Example 8 or 9) is added to the CuO/Sm2O3-coated porous silica bead, mixed, and then heated at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo1₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated inside at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 6

The P-38IJ series catalyst is synthesized as follows: 115 ml of 1.0-1.5 M Cu (II) nitrate plus 0.05-0.225 M of Pr(III) mixture is added to 250 cc of porous silica beads (ChemSource Inc., Grade TS-1, 1.0 to 2.0 mm), stirred, and then fired at 400-500° C. for 36 to 48 hours. After allowing to equilibrate to ambient temperature and ambient relative humidity for 18 to 24 hours, 115 ml of 5PMA catalyst reagent containing 0.0013 mole of phosphomolybdic acid hydrate (H₃PO₄Mo₁₂O₃₆.48H₂O), 0.000254 mole of gamma cyclodextrin, 5.16E-05 mole of hydroxy-propyl beta-cyclodextrin, 0.000194 mole of beta cyclodextrin, 0.000271 mole of CaBr₂, 1.44E-05 mole CCl3COOH, 8.4E-07 mole of copper trifluoroacetylacetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O is added to the promoter(s)-coated porous silica beads, mixed, and then heated at 70° C. for about 15 to 20 hours. If needed, another coating of catalyst reagent 5Mn containing 0.000943 mole of phosphomolybdic acid hydrate (H₃PO₄Mo₁₂O₃₆.48H₂O), 1.84E-05 mole of CCl₃COOH, 1.06E-06 mole of copper trifluoroacetyl-acetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of MnCl₂.4H₂O, and 0.000157 mole of MnBr₂.4H₂O can be coated onto the intermediate catalyst. The catalyst is removed to a 45-65% relative humidity controlled room. When the density of the catalyst is within 0.55 to 0.60 g/cc, it is ready for packing into a catalyst bed and test.

### Example 7

The P-30D series catalyst is synthesized as follows: 115 ml of 1.0 M Cu (II) nitrate and 0.10 M Pr(NO₃)₃ is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO/Pr₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated inside a 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 8

The P-140C series catalyst is synthesized as follows: 115 ml of 1.0 M Cu (II) nitrate and 0.10 M Sm(NO3)3 is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO/Sm₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated inside a 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 9

The P-144C series catalyst is synthesized as follows: 115 ml of 1.0 M Cu (II) nitrate and 0.10 M Ho(NO₃)₃ is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO/Ho₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 10

The P-43E series catalyst is synthesized as follows: 115 ml of 1.0-1.5 M Cu (II) nitrate to which any one of the following promoters, or combination thereof, are added at concentrations between 0.05 M and 0.225 M: cerium (III) nitrate, cerium (IV) nitrate, chromium (III) nitrate, cobalt (II) nitrate, dysprosium (III) nitrate, erbium (III) nitrate, gadolinium (III) nitrate, holmium (III) nitrate, lanthanum (III) nitrate, neodymium (III) nitrate, praseodymium (III) nitrate, samarium (III) nitrate, scandium (III) nitrate, thulium (III) nitrate, ytterbium (III) nitrate, yttrium (III) nitrate, or zinc (II) nitrate. The mixture is then added to 250 cc of porous silica beads (ChemSource Inc., Grade TS-1, 1.0 to 2.0 mm), stirred, and then fired at 400° C. for 36 hours. After allowing to equilibrate to ambient temperature and ambient relative humidity for 18 to 24 hours, 115 ml of a modified 5Y catalyst solution containing 0.0013 mole of sodium vanadate, 5.382 mmol HCl, 0.000254 mole of gamma cyclodextrin, 5.16E-05 mole of hydroxypropyl cyclodextrin, 0.000194 mole of beta cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl2, 0.015287851 mole of CaCl₂.2H₂O, and 0.02061743 mole of CuCl₂.2H₂O are added to the CuO/promoter(s)-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a catalyst reagent mixture 5Mn containing 0.000943 mole of sodium (meta) vanadate, 3.52 mmol HCl, 0.000103 mole of beta cyclodextrin, 0.000123 mole of gamma cyclodextrin, 6.58E-06 mole of hydroxypropyl cyclodextrin, 1.84E-05 mole of CCl₃COOH, 1.06E-06 mole of copper trifluoroacetylacetonate, 0.004679 mole of CuBr₂, 0.000498 mole of Na₂PdCl₄, 0.007061 mole of PdCl₂, 0.01421648 mole of CuCl₂.2H₂O, 0.010307948 mole of MnCl₂.4H₂O, and 0.000157 mole of MnBr₂.4H₂O are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 11

The P-8C series catalyst is synthesized as follows: 115 ml of 11.0 M Cu (II) nitrate and 0.10 M Cr(NO₃)₃ is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO/Cr₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 12

The P-31C series catalyst is synthesized as follows: 115 ml of 1.0 M Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetylacetonate, 0.014051 mole of CuBr₂, 0.000464 mole of Na₂PdCl₄, 0.006466 mole of PdC₁₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a modified catalyst reagent mixture SCo containing 0.000943 mole of H4SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CoC₁₂.6H₂O, and 0.000157 mole of CoBr₂ are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 13

The P-150B series catalyst is synthesized as follows: 115 ml of 1.0 M Cu (II) nitrate and 0.05 M Nd(NO3)3 is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H4SiMo12O40), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO/Nd₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Cd containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of CdCl₂.2.5H₂O, and 0.000157 mole of CdBr₂ are added to the intermediate catalyst which is further heated inside at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 14

The P-31E series catalyst is synthesized as follows: 115 ml of 1.0 M Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000194 mole of beta cyclodextrin, 0.000254 mole of gamma cyclodextrin, 5.16E-05 mole of hydroxypropyl cyclodextrin, 0.000271 mole of CaBr₂, 1.44E-05 mole CCl₃COOH, 8.4E-07 mole of copper trifluoroacetylacetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Mn containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of MnCl₂.4H₂O, and 0.000157 mole of MnBr₂.4H₂O are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 15

The P-45A series catalyst is synthesized as follows: 115 ml of 1.0 M Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of 5Y catalyst solution containing 0.0013 mole of molybdosilicic acid hydrate (H₄SiMo₁₂O₄₀), 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Cd containing 0.000943 mole of molybdosilicic acid hydrate (H₄SiMo₁₂O₄₀), 1.8439E-05 mole of CCl₃COOH, 1.06E-06 mole of copper trifluoroacetylacetonate, 0.004679 mole of CuBr₂, 0.000498 mole of Na₂PdCl₄, 0.007061 mole of PdCl₂, 0.01421648 mole of CuCl₂.2H₂O, 0.010307948 mole of CdCl₂.2.5H₂O, and 0.000157 mole of CdBr₂ are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 16

The P-88H series catalyst is synthesized as follows: 115 ml of 1.1 M Cu (II) nitrate is added to 250 cc of porous silica beads (ChemSource Inc., Grade TS-1, 1.0 to 2.0 mm), mixed, and then fired at 450° C. for 36 hours. After allowing to equilibrate to ambient temperature and ambient relative humidity for 18 to 24 hours, 115 ml of a modified 5Y catalyst solution containing 0.0013 mole of sodium vanadate, 5.382 mmol HCl, 0.000254 mole of gamma cyclodextrin, 5.16E-05 mole of hydroxypropyl cyclodextrin, 0.000194 mole of beta cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of a 5Cd catalyst reagent mixture containing 0.000943 mole of sodium vanadate, 1.84E-05 mole of CCl₃COOH, 1.06E-06 mole of copper trifluoroacetyl-acetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl4, 0.007061 mole of PdCl₂, 0.010307948 mole of CdCl₂.2.5H₂O, and 0.000157 mole of CdBr₂ are added to the intermediate catalyst which is further heated at 70° C. for another 15 to 20 hours. The catalyst is removed to a 45-65% relative humidity controlled room. When the density of the catalyst is within 0.55 to 0.60 g/cc, it is ready for packing into a catalyst bed and test.

### Example 17

The P-106A series catalyst is synthesized as follows: 115 ml of 1.0 M Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a modified 5Y catalyst solution containing 0.0013 mole of sodium vanadate, 5.382 mmol HCl, 0.000254 mole of gamma cyclodextrin, 5.16E-05 mole of hydroxypropyl cyclodextrin, 0.000194 mole of beta cyclodextrin, 0.000271 mole of CaBr₂, 1.44E-05 mole CCl₃COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Mn containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of MnCl₂.4H₂O, and 0.000157 mole of MnBr₂.4H₂O are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 18

The P-106B series catalyst is synthesized as follows: 115 ml of 1.5 M Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a modified 5Y catalyst solution containing 0.0013 mole of sodium vanadate, 5.382 mmol HCl, 0.000254 mole of gamma cyclodextrin, 5.16E-05 mole of hydroxypropyl cyclodextrin, 0.000194 mole of beta cyclodextrin, 0.000271 mole of CaBr₂, 1.44E-05 mole CC13COOH, 8.4E-07 mole of copper trifluoroacetyl-acetonate, 0.014051 mole of CuBr₂, 0.000464 mole of Na₂PdCl₄, 0.006466 mole of PdCl₂, 0.015287851 mole of CaCl₂.2H₂O, and 0.02061743 mole of CuCl₂.2H₂O are added to the CuO-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Mn containing 0.000943 mole of H₄SiMo₁₂O₄₀ hydrate, 1.84E-05 mole of CCl₃COOH, 1.06E-06 mole of copper trifluoroacetylacetonate, 0.01421648 mole of CuCl₂.2H₂O, 0.004679 mole of CuBr₂, 0.000103 moles of beta cyclodextrin, 0.000123 mole of gamma cyclodextrin, 6.58E-06 mole of hydroxypropyl cyclodextrin, 0.000498 mole of Na₂PdCl₄, 0.007061 mole of PdCl₂, 0.010307948 mole of MnCl₂.4H₂O, and 0.000157 mole of MnBr₂.4H₂O are added to the intermediate catalyst which is further heated inside a Yamato oven at 70° C. for another 15 to 20 hours. The catalyst is removed to a 45-65% relative humidity controlled room. When the density of the catalyst is within 0.55 to 0.60 g/cc, it is ready for packing into a catalyst bed and tested.

### Example 19

The P-95B beads series catalyst is synthesized as follows: 115 ml of a 1.1 M solution containing 5% Cr(NO₃)₃ and 95% Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a modified 5-PMA catalyst solution containing 0.00168 M Beta-cyclodextrin, 0.00220 M gamma-cyclodextrin, 0.00045 M hydroxypropyl cyclodextrin, 0.17928 M CuCl₂.2H₂O, 0.122179 M CuBr₂, 0.0001255 M CCl₃COOH, 0.0000 M copper trifluoroacetyl-acetonate, 0.05623 M PdCl₂, 0.00404 M Na₂PdCl₄, 0.132925 M CaCl₂.2H₂O, 0.002356 M CaBr₂, 0.024358 M H3 Mo₁₂O₄₀ is added to the CuO—Cr₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Cd-PMA containing 0.000891 M Beta-cyclodextrin, 0.001073 M gamma-cyclodextrin, 0.000057 M hydroxypropyl cyclodextrin, 0.123622 M CuCl₂.2H₂O, 0.040683 M CuBr₂, 0.000160 M CCl₃COOH, 0.000009 M copper trifluoroacetylacetonate, 0.06141 M PdCl₂, 0.004327 M Na₂PdCl₄, 0.089634 M CdCl₂.2.5H₂O, 0.001367 M CdBr₂, 0.017652 M H₃MO12O40P is added to the intermediate catalyst which is further heated inside a drying oven at 70° C. for another 15 to 20 hours. The catalyst is removed to a 45-65% relative humidity controlled room. When the density of the catalyst is within 0.55 to 0.60 g/cc, it is ready for CO oxidation testing.

### Example 20

The P-95B ground series catalyst is synthesized as follows: 115 ml of a 1.1 M solution containing 5% Cr(NO₃)₃ and 95% Cu (II) nitrate is added to 250 cc of porous silica beads (ChemSource Inc., Grade TS-1, 1.0 to 2.0 mm), mixed, and then fired at 400° C. for 36 hours. After allowing to equilibrate to ambient temperature and ambient relative humidity for 18 to 24 hours, 115 ml of a modified 5-PMA catalyst solution containing 0.00168 M Beta-cyclodextrin, 0.00220 M gamma-cyclodextrin, 0.00045 M hydroxypropyl cyclodextrin, 0.17928 M CuCl₂.2H₂O, 0.122179 M CuBr₂, 0.0001255 M CC13COOH, 0.00001 M copper trifluoroacetyl-acetonate, 0.05623 M, PdCl₂, 0.00404 M, Na₂PdCl₄, 0.132925 M CaCl2.2H2O, 0.002356 M CaBr2, 0.024358 M H3Mo12O40P is added to the CuO—Cr2O3-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Cd-PMA containing 0.000891 M Beta-cyclodextrin, 0.001073 M gamma-cyclodextrin, 0.000057 M hydroxypropyl cyclodextrin, 0.123622 M CuCl2.2H2O, 0.040683 M CuBr2, 0.000160 M CCl3COOH, 0.000009 M copper trifluoroacetylacetonate, 0.06141 M PdCl2, 0.004327 M Na₂PdCl4, 0.089634 M CdCl2.2.5H2O, 0.001367 M CdBr2, 0.017652 M H3MO12O40P is added to the intermediate catalyst which is further heated inside a Yamato oven at 70° C. for another 15 to 20 hours. When the density of the catalyst is within 0.55 to 0.60 g/cc, it is then ground into powder to increase surface area so that only 1-gram of the catalyst is needed to achieve the same CO oxidation performance as the 3-grams in 1-2 mm beads form.

### Example 21

The P-128A ground series catalyst is synthesized as follows: 115 ml of a 1.4 M Cu (II) nitrate is added to 250 cc of porous silica beads (ChemSource Inc., Grade TS-1, 1.0 to 2.0 mm), mixed, and then fired at 400° C. for 36 to 48 hours. After allowing to equilibrate to ambient temperature and ambient relative humidity for 18 to 24 hours, 115 ml of a modified 5-PMA catalyst solution containing 0.00168 M Beta-cyclodextrin, 0.00220 M gamma-cyclodextrin, 0.00045 M hydroxypropyl cyclodextrin, 0.17928 M CuCl₂.2H₂O, 0.122179M CuBr₂, 0.0001255 M CCl₃COOH, 0.00001 M copper trifluoroacetyl-acetonate, 0.05623M, PdCl₂, 0.00404M, Na₂PdCl₄, 0.132925 M CaCl₂.2H₂O, 0.002356 M CaBr₂, 0.024358M H₃Mo₁₂O₄₀ is added to the CuO—Cr₂O₃-coated porous silica beads, mixed, and then heated inside a Yamato oven at 70° C. for about 15 to 20 hours. Again, after allowing to equilibrate to ambient temperature and ambient relative humidity for 18 to 24 hours, 115 ml of catalyst reagent mixture 5Cd-PMA containing 0.000891 M Beta-cyclodextrin, 0.001073 M gamma-cyclodextrin, 0.000057 M hydroxypropyl cyclodextrin, 0.123622 M CuCl₂.2H₂O, 0.040683M CuBr₂, 0.000160 M CCl₃COOH, 0.000009 M copper trifluoroacetylacetonate, 0.06141M PdCl₂, 0.004327 M Na₂PdCl₄, 0.089634 M CdCl₂.2.5H₂O, 0.001367 M CdBr₂, 0.017652M H₃MO₁₂O₄₀P is added to the intermediate catalyst which is further heated inside a Yamato drying oven at 70° C. for another 15 to 20 hours. The catalyst is removed to a 45-65% relative humidity controlled room. When the density of the catalyst is within 0.55 to 0.60 g/cc, it is then ground into powder to increase surface area so that only 1-gram of the catalyst is needed to achieve the same CO oxidation performance as the 3-grams in 1-2 mm beads form.

### Example 22

The P-46B ground series catalyst is synthesized as follows: 115 ml of a solution mixture of 1.1 M Cu(NO₃)₂ and 0.055 M Cr(NO₃)₃ is added to 250 cc (110 g) of porous silica beads (ChemSource Inc., Grade TS-1, 1.0 to 2.0 mm), mixed thoroughly, and then fired at 450° C. for 48 hours. After allowing to equilibrate to ambient temperature and ambient relative humidity for 18 to 24 hours, 115 ml of a modified 5Y-PMA catalyst solution containing 0.00168 M Beta-cyclodextrin, 0.00220 M gamma-cyclodextrin, 0.00045M hydroxypropyl cyclodextrin, 0.17928 M CuCl₂.2H2O, 0.122179 M CuBr₂, 0.0001255M CCl₃COOH, 0.00001 M copper trifluoroacetyl-acetonate, 0.05623M, PdCl₂, 0.00404M, Na₂PdCl₄, 0.132925 M CaCl₂.2H₂O, 0.002356 M CaBr₂, 0.024358 M H3Mo₁₂O₄₀P is added to the CuO—Cr₂O₃-coated porous silica beads, mixed, and then heated inside a Yamato oven at 80° C. for about 15 to 20 hours. The catalyst is removed to a 45-65% relative humidity controlled room. When the density of the catalyst is within 0.55 to 0.60 g/cc, it is then ground into powder to increase surface area so that only 1-gram of the catalyst is needed to achieve the same CO oxidation performance as the 3-grams in 1-2 mm beads form.

### Example 23

The P-60A ground series catalyst is synthesized as follows: 115 ml of a solution mixture of 1.1 M Cu(NO₃)₂ is added to 250 cc (110 g) of porous silica beads (ChemSource Inc., Grade TS-1, 1.0 to 2.0 mm), mixed thoroughly, and then fired at 450° C. for 48 hours. After allowing to equilibrate to ambient temperature and ambient relative humidity for 18 to 24 hours, 115 ml of a modified 5Y-PMA catalyst solution containing 0.00168 M Beta-cyclodextrin, 0.00220 M gamma-cyclodextrin, 0.00045 M hydroxypropyl cyclodextrin, 0.17928 M CuCl₂.2H₂O, 0.122179 M CuBr₂, 0.0001255 M CCl₃COOH, 0.00001 M copper trifluoroacetyl-acetonate, 0.05623 M PdCl₂, 0.00404 M Na₂PdCl₄, 0.132925 M CaCl₂.2H₂O, 0.002356 M CaBr₂, 0.024358 M H₃Mo₁₂O₄₀P is added to the CuO—Cr₂O₃-coated porous silica beads, mixed, and then heated inside a Yamato oven at 80° C. for about 15 to 20 hours. The catalyst is removed to a 45-65% relative humidity controlled room. When the density of the catalyst is within 0.55 to 0.60 g/cc, it is then ground into powder to increase surface area so that only 1-gram of the catalyst is needed to achieve the same CO oxidation performance as the 3-grams in 1-2 mm beads form.

Examples 16-21 are for room to 85° C., for oxidation of CO in hydrogen for fuel cell application include copper oxide and other mixed oxides on the surface of the substrates as described in Substrate 9.

Examples 20-23 are for room to 85° C., for oxidation of CO in air for air purification include copper oxide, chromium oxide, and/or mixture of the two on the surface of the substrates.

Example 22 outperforms all the others in removal CO in air at low to high relative humidity and ambient temperature. It also has only about 0.6% Palladium, compared to 1% to 2% for all the other examples. Example 23 is preferred if and when chromium oxides are of health concern.

The P catalysts series stated above contain: 1) a coating of copper oxide or mixture of copper and other metal oxides such as those of chromium and samarium coated on porous silica substrate support (ChemSource TS-1, 1-2 mm; 2) a single or multiple coatings of a catalyst reagent, which may contain sodium vanadate (5NaV), phosphomolybdic acid (5PMA), bromide and chloride of cadmium or manganese as one exemplary embodiment to replace calcium (5Cd, 5Mn). Other exemplary embodiments replace calcium with zinc, chromium, manganese, cobalt, iron, and mixtures thereof and others add rare earth oxides and mixtures thereof.

Health concerns surrounding Cd and Cr may reduce the exemplary embodiments to those catalysts which contains no Cd, Cr, and any metals and metal compounds that are not ROHS compliant for CO removal for air purification application

### BACKGROUND OF THE INVENTION

The need to remove high concentrations of CO from a gas stream rapidly has many applications including the production of zero air for CO instruments, filling diving air tanks, the production of ammonia, improving safety and providing a CO removal for air purification to improve health in homes, health facilities, public buildings, transportation systems, the workplaces, commercial and industrial facilities and other enclosed structures where living things exist and to control CO from reformers for fuel cells.

The fuel cell was invented more than 150 years ago. Since that time various governments and industry have pumped billions of dollars into the development of fuel cells, because of their potential advantages. These advantages include environmentally friendly, stealth, high efficiency as well as simplicity. In the 1980's General Motors concluded that the proton-exchange membrane (PEM) fuel cell was well suited for vehicle applications. The fuel cell coverts hydrogen and oxygen to electric power and water without the need for high temperature combustion. The process takes place at a much higher efficiency than heat engines. The theoretical efficiency of a fuel cell operating on hydrogen is about 83% (“Fuel Cell” Energy Handbook, DOE/IR/05114-1 Oak Ridge, Tenn., June 1982, pages 136 to 144 by S. Glasstone). Most PEM fuel cells operate in the range of 60° C. to 90° C., which makes its platinum-based fuel cell catalyst extremely sensitive to CO poisoning. The CO bonds to platinum more aggressively than hydrogen and the power density are greatly reduced by CO; however, pure hydrogen can restore the catalyst once the CO is reduced.

Therefore, it is very important to remove CO or reduce the concentration of CO during operation of the fuel cell. The lower the CO-level the better the efficiency of PEM type of fuel cells. In addition, protecting living things from CO is also important as they function much better if the CO is less than 10 ppm. Although recent progress has shown that doping the platinum with other metals such ruthenium has produced alloys that are tolerant to 300 ppm CO in a PEM fuel cell electrode (Private Communication with Stan Simpson Honeywell November 2001).

The CO danger is well known; EPA stated that 3.75 million workers were exposed to harmful levels of CO from motor vehicles in a single year. Over 5,600 people lose their lives annually due to carbon monoxide (CO) generated by various sources such as fires, combustion appliances and vehicles according to Cobb and Etzel JAMA. The death certificate data review by Cobb and Etzel does include the many deaths CO cause from chronic sources such as cigarettes, cracked heat exchangers, ovens and ranges as well as other low level exposures. The Surgeon General Edward Coop's estimated that 50,000 fatalities occur every year from passive smoke. In addition, according to the National Highway and Safety Administration over 100 people lost their lives as a result of CO in moving vehicles in 1993. Princess Diane's driver was poisoned with CO as proven by a test on his blood indicating, i.e., about 20% carboxyhemoglobin (COHb). Therefore, CO sensor and detector have been developed for gasoline powered IC engine vehicles as well as fuel cells.

Means have been developed for providing CO sensor safety and CO removal for vehicle occupants. These biomimetic sensors mimic the human response to CO and can include a mixture of palladium molybdenum and copper. This mixture was short lived and did not work over a wide range of temperature and humidity required by CO alarm standards and therefore advances were made using an organic material derived from a genetically modified bacterium to form a supramolecular complex. These cyclodextrins and several derivatives produce a supramolecular complex that self-assembles on an activated substrate and exhibited properties that improve and stabilize the catalytic activity and increased the sensor performance.

Catalyst improvements have included modification to optimize conversion of CO to CO₂ in both air and hydrogen. In addition, these catalysts have increased chemical stability and catalytic performance. There are a number of sensors that have been disclosed in the following U.S. Pat. Nos., e.g., 4,043,934, 5,346,671, 5,405,583, 5,618,493 and 5,302,350, which can detect a target gas such as CO by monitoring the optical properties of the sensor. In addition, a single sensor in a SIR system has been demonstrated to meet the UL 2034 effective Oct. 1, 1998.

Several CO detector systems have been developed, which incorporate several types of optical changing sensors including the biomimetic sensor as discussed above. Other sensing methods include a digital and rapid regenerating means. The K chemistry of this fast regeneration sensor was the first formula to provide long-term stable catalytic function.

In addition, some preferred embodiments of this CO catalyst invention can be placed on the vehicle or in a location between the reformer and the fuel cell stack. These types of CO catalyst products may be operated without power as long as the gas is flowing into the bed with some pressure to provide for flow.

Some novel system contains catalyst(s) that need components to be replaced every few years are described herein. A warning means may be incorporated into a novel fuel cell catalyst system that is based on operating hours or performance. The regeneration rate of a sensor at the front of or located within the catalyst bed with similar chemistry may be use to predict the catalyst bed lifetime. Also the getter is an important component of the catalytic system.

Like the K sensor series, the life of the P catalyst series is also dramatically improved as the copper ion and copper oxide concentrations increase; therefore, the life of the catalyst can be predicted well before failure by making a test sensor with slightly lower copper ion concentration than the catalyst and monitoring its regeneration rate. When regeneration slows down substantially, it may be time to replace the catalyst bed.

The catalyst lifetime can also be increased by filtering out ammonia and/or amines from the hydrogen and/or air streams before passing through catalytic beds. Ammonia scrubbers are extremely porous and useful in fuel cell applications. This ammonia scrubber is currently incorporated into the SIR system CO alarms. Laboratory test results indicated that the scrubbers can extent the sensor life from 3 to 46 years assuming an average of 40-ppb ammonia in the home.

Air purification has been around for many years, however, the main focus has been the removal of: 1) solid pollutants such as dust, allergens, bacteria, 2) liquid pollutants such as mist, fog, and aerosol-sprays, and 3) gaseous ones such as odor, VOCs and formaldehyde, but not carbon monoxide. Solid and liquid pollutants can be effectively removed by media filters such as HEPA filter. However, gaseous pollutants are extremely small (<0.001 microns) and pass right through the HEPA filter. Activated carbon with high micropore surface area is well known for its ability to remove gaseous odors and volatile organic compounds such as benzene, toluene, styrene under home and office conditions. However, activated carbon is not effective for removing less volatile compounds such as formaldehyde or many inorganic gases such as hydrogen sulfide and sulfur dioxide. These compounds require a chemical reaction to break them down to harmless CO2. Chemisorbers (aluminoxyde coated with potassium permanganate) are best suited for this application. However, it too cannot remove CO.

The short and long term effects of CO on human health have been well documented. For example, the U.S. EPA promulgated the “Air Quality Criteria for Carbon Monoxide” in June 2000 based on an extensive report by the same title referred to as EPA/600/P-99/001F June 2000. On the basis of the scientific information contained in this EPA document, the National Ambient Air Quality Standards (NAAQS) for CO exposure limits were set at levels of 9 parts per million (ppm) for an 8-hour average and 35 ppm for a 1 hour average. The EPA sought out the experts in the field in the preparation of this document. The document studied the short and long term health effects of CO exposures to the human body for CO levels that range from 15 ppm [2.5% carboxyhemoglobin (COHb)] to 500 ppm [80% COHb]. According to this EPA report, there are significant and measurable health impacts on both the healthy and sensitive populations starting at as low as 15 ppm. At 50 ppm, these effects become much more serious. The health effects below 2.5% COHb on sensitive populations are inconclusive; however, epidemiological studies by the U.S. Surgeon General indicate that CO from second-hand smoke contributes to cardiovascular disease and early death. Other similar studies for tunnel and bus workers indicate that there is a strong correlation between low level (10-24 ppm CO), long term exposure of CO and the risk of coronary heart disease.

There exists a need for CO removal in air purification. While most typical air purifiers comprised a prefilter, a HEPA filter, and an activate carbon filter, only one that is manufactured by SHARP for the marketing in Japan and Korea (but not other countries yet) has a CO removal capability. However, the performance of SHARP's current CO removal catalyst is inadequate.

### Disclosure

Certain vehicles such as electric cars powered by fuel cells are generally expected to comprise a hydrocarbon reformer to convert hydrocarbon to hydrogen, carbon dioxide, water and carbon monoxide etc. The CO sensing system may operate off of the main fuel cell and may also have a battery backup system. In addition, CO can be detected in some systems and if the CO level rises above a predetermined level than a value may direct the flow of reformate or other gas through a particular catalyst bed to remove the CO.

Carbon monoxide is often difficult to detect with optical sensors at high temperature in a hydrogen rich stream when high carbon dioxide is present. The temperature of the fuel cell's input is between 65° C. to 85° C. and the reformer's output is 250° C. Therefore, in this invention a cooling means is provided to reduce the temperature to the 60° C. to 85° C. range. Also, a switching means to switch the flow from air to a hydrogen rich reformate gas stream may be employed to cycle reformate gas first through one catalyst bed and then the other. Alternately air is cycled through the other catalyst bed.

In one embodiment of the invention, there are two beds and a switching system. The switching system may control a valve that connects the bed system to the reformer line at one end and to the fuel cell at the back end. One catalyst bed receives the hydrogen stream while the other one regenerates in an air stream. Depending on the volume of the catalyst bed, purging of hydrogen with inert gas such as N2 may be optionally employed. In addition, more than two catalytic beds may be used in the multi-regenerating methods.

This CO removal method is an improvement over earlier patent applications particularly for fuel cell and other applications where a small increase in efficiency will pay for the improved catalyst system very quickly.

The catalyst system (including switching means) is operated by circuitry incorporated into a system such as an automobile or power plant fuel cell reformer. In some cases, a dual or multiple catalyst system may be used so that a spare catalyst bed is always available if one becomes saturated or otherwise fails, thus protecting the fuel cell from damage. This system will be described below in detail.

There are a number of heat-exchanging methods including radiators and even thermoelectric device to cool the gas down to about 60° C. to regulate the gas temperature going to the catalyst and CO sensor. The gas may be then passed through a hydrophobic membrane to remove water and then warmed up slightly to say 65° C. to reduce and control % relative humidity (RH) between some broad limit such as 80 to 90% RH. The captured moisture during high humidity condition can be later added back to the gas or air stream if necessary to raise the level of RH or may be added to the fuel reformer catalyst or water shift reactor. The catalytic activity has been shown to be effective when the relative humidity of the gas is within the range of 20 to 90% RH in air at room temperature 23 degrees C. plus or minus 10 degrees C. This catalyst is even more effective under fuel cell operating temperature conditions at humidity values from 60 to 90% RH, other values of RH also work well and could be used for any number of applications. Zero % RH and 100% RH must be avoided, as they will not work for any substantial length of time; however, in the real world these extreme are rare they are generally of little concern in homes, business and transportation systems.

Air below 50% RH has been shown to regenerate catalyst as well as air from 50% RH to 95% RH air, but long term adding some moisture to dry air may be preferred in fuel cell applications.

These catalyst beds comprise one self-regenerating reagent self-assembled onto high surface area substrates such as porous glass or porous silica, or porous monoliths. The substrate may be made of a solid-state material that has a mesh 8×12 and a pore size 10 nm to 30 nm that enables rapid conversion of CO to CO₂. Also 1.0 mm to 3.0 mm porous silica beads may be used, which have an average pore diameter of about 15 nm.

A sensor may be added to test the effectiveness of the catalyst system and to control the reformer and CO conversion devices through some means and actuate controls as programmed depending on the CO level or other conditions. Any one of the several software-hardware combinations described in U.S. Pat. Nos. 5,624,848 and 5,573,953 herein incorporated by reference may accomplish this. One of the preferred sensor formulations for this low ppm application is S50.

A temperature feedback may be implemented in order to control the catalyst operation at the temperature of maximum efficiency and life in fuel cell applications. The temperature of operation may be between 60° C. to 95° C. depending on the type of PEM fuel cell used.

Another feature of the invention for use in the fuel cell incorporates two catalyst beds and a valve system for alternating between air and hydrogen in order to keep the system effective in removing CO from hydrogen containing gas stream. For example, as one catalyst changes it optical properties or uses up its oxidation potential in the hydrogen stream, the valve system will switch out the hydrogen gas stream to a second catalytic bed and immediately switch in the air line to regenerate the first exhausted catalyst. To insure extra safety, an optional valve system may comprise an additional N₂ line for the initial purge out of hydrogen from the exhausted catalyst bed before air.

Another method is to flow the hydrogen stream containing the CO through the one catalyst bed for a predetermined time or until the level of CO increases above a predetermined CO concentration, then the hydrogen stream is directed or switched to another catalyst bed. Then clean air is flowed through the first bed, which will regenerate it back to the original state.

It may be useful to clean the in-coming air in order to remove CO and other contaminates so that the regeneration proceeds rapidly in the fuel cell and in the cabin so the people health is maintained for extended periods of time. In addition, measuring and controlling temperature (T) and RH will allow a more reliable CO cleaning system to be developed and removing other air contaminates also extents the life of the catalyst. These getter systems developed so far use charcoal or activated porous carbon spheres coated with acid to remove basic gases such as ammonia and other cleaners.

One embodiment of the invention uses a dual catalyst bed. The catalyst system's first catalyst bed will be purged with air for a few minutes e.g., 5-10 minutes while the other is removing CO from the reformate gas stream.

Another embodiment of the invention is a simple catalyst system without any switching may also be used as a filter to remove CO from the air intake of the fuel cell; vehicles or other enclosed structures. In addition static system may be employed in a closed or near enclosed structure such as a car, aircraft, tent, shelter, boat or room.

Another embodiment uses the static catalyst to clean CO from air in the cabin to improve air quality for people.

In some preferred embodiments, when the CO concentration becomes higher and higher and the oxygen concentration is low, the catalyst changes to dark blue. This feature may be used in a self-sensing catalyst bed system to shift from one catalyst bed to another by monitoring the light passing through a portion of the bed or by monitoring the reflected light from the bed. However in air system this is unlikely and a CO sensor with control circuitry may be used to tell the consumer the catalyst needs changing. For example two sensors may be employed at the intake and outtake of a catalyst system. If the CO is the not reduced significantly below the intake then a signal may be used to alert some to change the filter system or catalyst. It is also possible to combine one or more of the above embodiments. The time to change the flow in a system can be determined by monitoring the sensor and thus possibly eliminating the need for CO sensors. The reflection off the surface of an optically changing catalyst can be monitored by means of at least one LEDs and a photodetector. The intensity of light reflected from the surface will change proportional to the CO saturation if we choose are wavelength carefully.

The catalyst beds require maintenance and cannot operate for many years without changing the getter and filter systems. A CO control apparatus and method suitable to tell the vehicle operator of fuel maintenance people when to change the filter. These filters and/or getters can be used to remove ammonia and other contaminates and the filter can remove particulates as well as other gases.

One skilled in the art may appreciate a lightweight low powered CO catalyst control apparatus, which can also measure and display CO saturation. One skilled in the art may appreciate a CO catalyst system that does not consume hydrogen. Today most catalysts require high temperature and are operated with air, which is difficult to control. They require lots of maintenance and cannot operate for years or even monthly without monitoring. A CO sensing and controlling apparatus and method suitable for a wide variety of applications such as laboratory, government, home, industrial, commercial, military, medical computer, cell phone and automotive applications is desirable. Such a CO control device and method should be fast, accurate, reliable, low power, very selective and durable. Quantum Group Inc.'s CO catalysts can be used either statically in enclosed structure or incorporated into air cleaning system that move air. In addition, these catalysts can be combined to produce a fuel cell reformer selective oxidation catalyst system with multiple beds and also can be combined with CO sensors to monitor CO and may be key to commercial success of the PEM fuel cell.

In a static CO removal catalyst system for air purification, a pH indicator may be incorporated into the getter such that it changes color to alert people to the need to replace the catalyst. The getter may be an acid such as poly(methyl vinyl ether/maleic acid) (PVMA), phosphoric acid, or citric acid bonded to a substrate such as polyester felt, silica gel or beads, and/or carbon filter or beads. The amount of getter use can be adjusted for a desired lifetime. The pH indicator and the getter may be packaged inside a small porous plastic transparent bag for easy viewing of color change.

Another method to alert the people when to change the catalyst is to simply use Quantum Group Inc.'s already existing CO indicating product known as the “QuantumEye.” Since it is already a commercial product, QuantumEye incorporates a getter protection against ammonia/amine and VOCs. The idea is that when the CO removal catalyst reaches its end-of-life and needs to be replaced, the CO concentration in a home is expected to drop very slowly (due to minor leakages), or rise (if the CO generating source is constantly releasing more CO), or remains fairly constant (if the rate of CO generation equals to the rate of CO leakage). In any of these cases, the QuantumEye would respond to CO by changing from NORMAL (yellow) to CAUTION (green) and then to DANGER (dark blue) to let the people know that the catalyst is dead and must be replaced.

### BRIEF DESCRIPTION OF THE DRAWINGS

FIG. 1 is a graphic representation of the results shown in Table 6.

FIG. 2 is a CO removal system powered by an electric fan at the top, which move the air down to the bottom through the catalyst.

FIG. 3 is similar to 2 except the electric fan move the air from bottom to top.

FIG. 4 is a static catalyst system contained in a housing.

FIG. 5 is a process flowchart for fabricating a typical CO removal catalyst.

FIG. 7 is a graphic representation of the results shown in Table 8.

FIG. 10 is a graphic representation of catalyst 801 performance at 30±3% RH/23±3° C., 50±5% RH/23±3° C., and 80±5% RH/23±3° C.

FIG. 11 is a bar graph showing the comparative performances between two catalysts at 50±5%% H and 23±3° C. One was fabricated using a copper oxide on silica bead substrates 1101 and the other was made using a mixed copper and chromium oxides, also on silica bead substrate 1102.

FIG. 12 is a bar graph showing the comparative performance between two catalysts per FIG. 11 at three different low, ambient, and high relative humidity test conditions

### SUMMARY OF THE INVENTION

Improvements have been made in CO removal in hydrogen rich gas stream for fuel cell application. Some are ideal for CO removal in air for air purification; and some are good for both applications.

The improved embodiments of the present invention depending on the application, i.e., an apparatus and method for determining the concentration of CO in a fuel cell hydrogen rich reformer stream and catalyzing the CO to CO₂ as needed by a fuel cell. These CO catalyst systems are used as means to remove CO below a predetermined CO level for a fuel cell reform system including feedback data to allow optimization of the reformer operation.

Another important embodiment of this invention is incorporated into both fixed and portable reformer/fuel cell systems with sensor and circuit/software system with a multi-catalyst bed system. This built-in CO catalyst system can be used to in conjunction with CO sensors to control CO from the reforming process.

If problems with CO catalyst occur because of saturation, a warning visual and/or audio signal on the vehicle's dashboard may be actuated as an indicator if the CO increases above a predetermined level. A light can flash to indicate possible high levels of CO; further danger can result in louder audio warning, which may eventually shut down the fuel system supply to the fuel cell if it is not operating safely.

One aspect of this novel solid-state catalyst system is that it regenerates in air, therefore a multiple catalyst beds may be used with at least one sensor in the air stream and another in the hydrogen stream. An automated circuit based on a microprocessor with sensing logic enables the continuous switching between reformer gas and air to remove CO going to the fuel cell below a predetermined level. The switching occurs at some predetermined points by monitoring a sensor or the catalyst itself, time or a combination. A circuit and a microprocessor means can be used to measure the rate of change of sensor and the percent transmission of the sensor. A control means may be used to modify the operation of the reformer and the associated system to minimize the CO and maximize the efficiency of the fuel cell operation. In some cases, the catalyst itself may be used as the sensor.

The catalyst contains supramolecular complexes coated onto porous element, which converts CO to CO₂ in a reformer stream or in air. An example of a system, which is designed to increase the efficiency of the PEM fuel cell system, by removing CO below a predetermined level, which is known as the carbon monoxide catalyst system (COCS).

In addition, it is useful to be able to control the catalytic converter systems for automotive and many other air cleaning applications; removing CO from air intake of the fuel cell and the cabin or room air of an enclosed structure, instrument zero air, breathing air in a tank, and for application where zero air is required or desired. In order to alert the driver, occupant and/or the operator of a need to service a fuel cell, the need to provide maintenance to the fuel cell system such as the catalyst bed, filter or sensor systems, and warning signals of some kind may be indicated by means of a signal from an electronic monitor or a color indicating system as discusses above.

Furthermore, the improved preferred embodiments of this invention vary widely depending on the application; e.g. a catalyst system to reduce CO levels into the fuel cell, breathable air, instrument air and any other applications to reduce CO input. In the air purification in static system where speed is not critical a static catalyst system may be used very economically.

### DETAILED DESCRIPTION OF DRAWINGS AND TABLES

The present invention is useful in the substantial removal up to about 99% of 2,000 to 10,000 ppm CO from a hydrogen rich stream without consuming much hydrogen. This is extremely important for various types of fuel cell applications such as proton exchange membrane (PEM) fuel cell and others. The present invention involves a series of Pd and Cu based catalysts, which can reduce 2,000 to nearly 10,000 ppm CO to within 5 to 170 ppm without substantial loss hydrogen. Experimental data, which verifies these statement is shown in Tables 1-7.

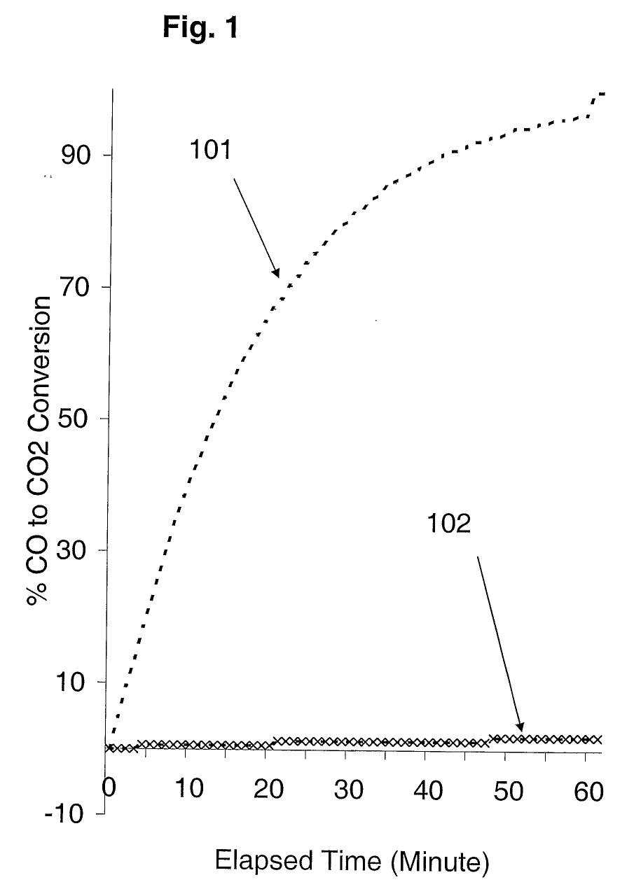

FIG. 1 is a graphic representation of the results shown in Table 1, which tracks the percentage of CO conversion at different time. Without CO catalyst 102, no CO conversion took place. With only about 3-grams of CO catalyst type 106A 101, 82% of 150-ppm CO has been converted in 30 minutes. The test was conducted at standard laboratory room temperature and pressure with relative humidity maintained within 30 to 80%. 3 grams of catalyst 106A 101 (coated 1.0-2.0 mm diameter, porous SiO2-based substrate) was placed in a 96 mm diameter petri dish inside a 10 L chamber, containing a Dreager Pac III CO analyzer/data logger for reading the remaining CO concentration in the chamber. For the test without the CO catalyst, 3 grams of blank 102 (uncoated, 1.0-2.0 mm diameter, porous SiO₂ beads) was replaced the 3-grams of catalyst 106A. Within 30 minutes, 3 grams of catalyst 106A 101 was able to reduce the CO concentration by 82%, compared to 1% “without catalyst” 102.

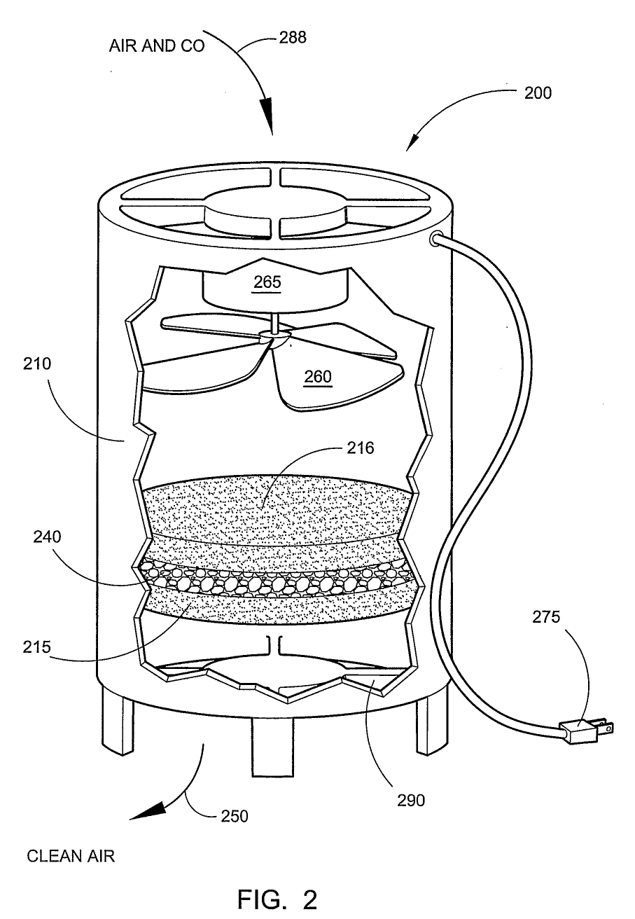

FIG. 2 is a CO removal system 200, which consist of a tubular shaped housing 210, an electric motor 265, fan blade 260 at the top of the unit to pull in the contaminated air 288 through the first pre-filter, and then push the air through the second pre-filter, then the HEPA filter through the first getters systems 215 and then through the catalyst to remove CO 240 and then through the second getter 216. The air purifier may be AC powered by means of an AC plug 275. The getters may consist of a felt coated with Polyvinyl Methyl Acrylic Acid (PVMA) or other acid impregnated in porous carbon with an acid such as H₃PO₄ or other non-volatile acids. The porous activated carbon may be held between two pieces of plastic (not shown). A pre-filters 223 and 224 may be located immediately before and after the air intake to remove the lint, dust and other larger particles followed by a HEPA filter (222), and impregnated activated carbon filter (215) followed by catalyst 240 and then by impregnated activated carbon filter or getter 216. The contaminated air containing CO 288 is passed through a series of these filters inside the tube 210 and through the getters (216 and 215) and catalyst 240 where CO is oxidized to CO₂. The getters 216 and 215 remove VOCs and basic gases such as ammonia and amines. Clean air 250 exits the bottom. Together the getter 215, the catalyst 240, and the getter 216 are placed on the mechanical support structure 290. The inside of the tube 210 can be made to have grooves to allow porous grids for holding the stack of the entire filtration system in place. The entire system is further supported by the multiple legs 295.

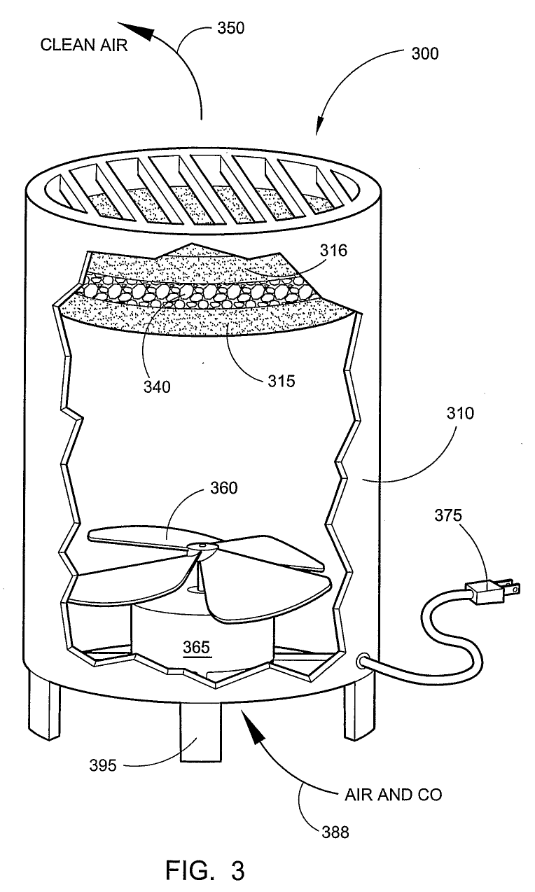

FIG. 3 is a CO removal system 300 comprising a tubular housing 310. In this case the motor 365 is located at the bottom and the fan 360 is above it, forcing the contaminated air 388 up from near the legs 395 through the pre-filter (not shown), HEPA filter (not shown), and the carbon filter (not shown) to the getter 315 to the catalyst 340 through the second getter 316 out the exit emerges clean air 350. The inside of the tube 310 can be made to have grooves to allow porous grids for holding the stack of the entire filtration system in place. There needs to be a power source to drive the air movement means such as a fan 360, which can be hardwired, battery or an electric plug 375 powered as illustrated.

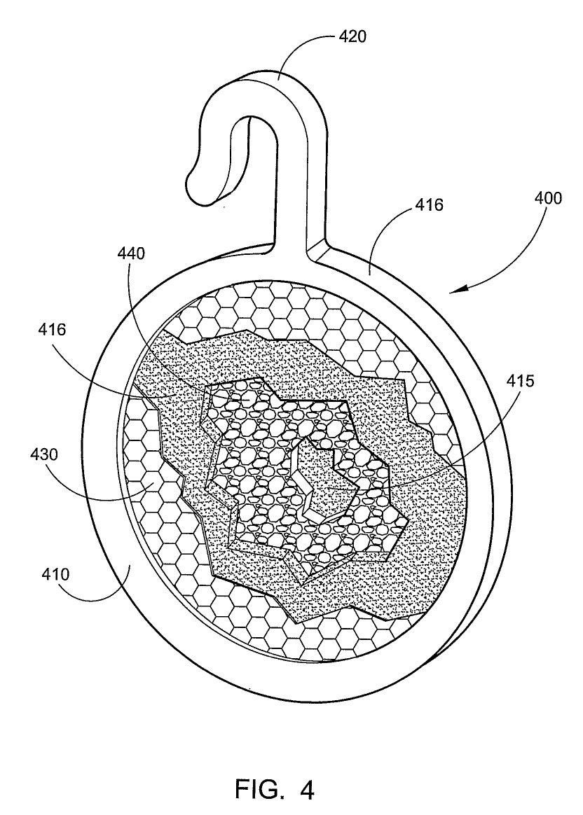

FIG. 4 is a non-powered air cleaning system 400 that relies on simple diffusion and/or air circulation. This device may be employed in closed or semi-closed environment such as an aircraft, car, truck, RV or room. The device 400 may be mounted (not shown) or built in (not shown). In this design a hook 420 is provided to hold the device in a car or other location. This device may be any shape but for illustration purposed a rounded design is shown 410. The device consists of two screens 430 to hold the two getters 416 and 415, which are mounted so as to contain and protect the catalyst 440. Additional filters such as a pre-filter (not show), HEPA filters (not shown) and/or carbon filters (not shown) may be installed on one or booth sides. The air containing CO is located in the environment (not shown). It is the diffusion gradient that develops at any CO in the vicinity of the catalyst is converted to CO2.

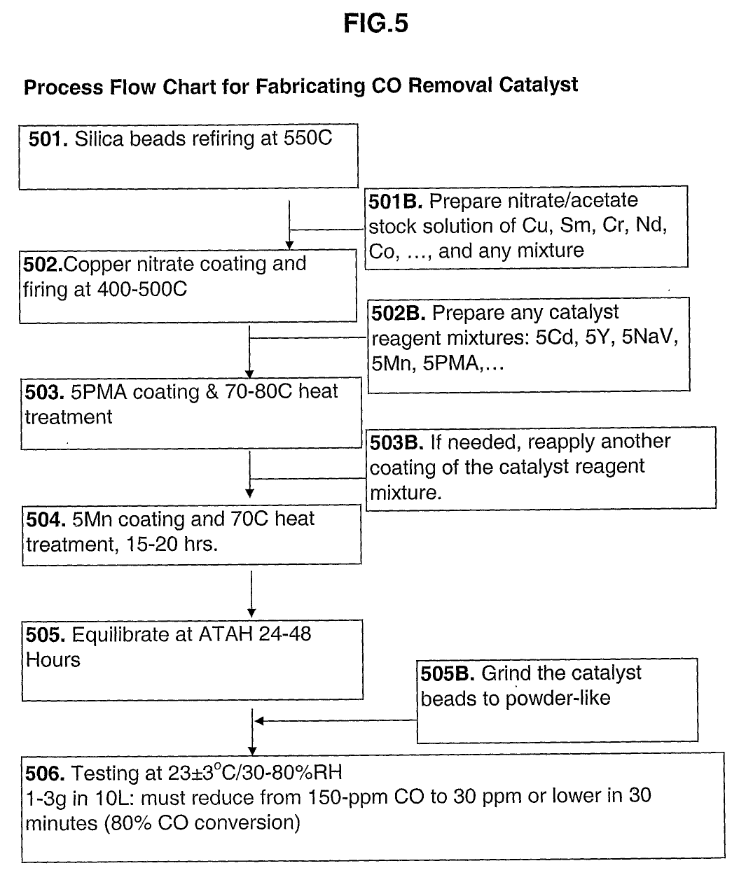

FIG. 5 is a typical process flowchart for fabricating CO catalysts. First if the silica substrate appears to be dirty, then is fired at 500-600° C. to remove organic contaminants 501. Mixture of a nitrate solution of Cu, Cr, Sm, Pr, or any mixture therefore is prepared in an aqueous solution 501B and then coated onto the silica substrate and fire at 400-500° C. to form mixed metal oxides on the silica substrate 502. Next any catalyst reagents such as 5Y, 5Cd, 5NaV, 5Mn, or 5PMA is prepared 502B and then coated onto the metal oxide-coated-silica and heat treated at 70-80° C. (503). If needed, a second coating of a catalyst reagent is applied and heat to dry at 70-80° C. 504. Hereafter, a given CO catalyst formulation is allowed to equilibrate to ambient humidity and ambient temperature 505 before it should be tested for CO conversion 506. Grinding 505B of the catalyst beads prior to CO results in 3 times the performance of that whole beads such that 1 gram of ground catalyst is as good as 3 gram of catalyst beads for any given catalyst formulation. This reduces the material cost by about 66%.

The results shown in Table 7 compare % CO conversion of the Quantum Group Inc.'s previous catalysts 10K 601 and 5Y 602 to those of the newly innovated catalyst P-106A 603, P-95B 604, and P-46B 605 in term of their ability to remove 150-ppm CO in air inside a 10 L chamber within 30 minutes.

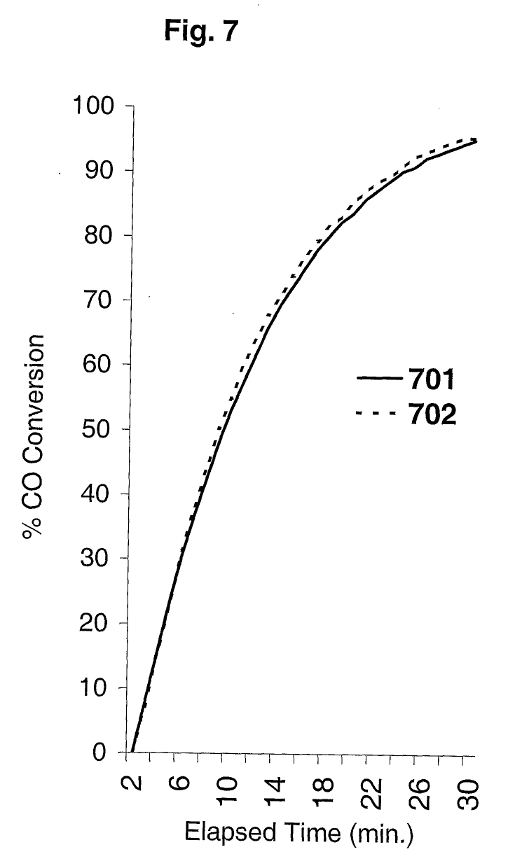

FIG. 7 is a plot of % CO conversion, comparing 1.0 gram of ground catalyst 701 versus 3.0 gram of 1-2 mm, spherical beads 702. Both were P-95B catalyst series. Note that 1.0 gram of ground catalyst performed as well as the 3.0 grams whole-bead catalyst. The test was conducted at ambient temperature and relative humidity of 5015% and 23±3° C. The 1.0 gram of ground and the 3.0 grams of whole beads were placed inside separately test chambers. Each chamber had 10 L volume and contained a Drager Pac III CO analyzer/data logger for reading the remaining CO in the chamber. 31 cc of 5% CO was injected into each chamber to create 150-ppm CO. A micro fan inside each chamber was used to circulate the air inside each chamber. The chamber was vented at the end of 30 minutes. Each catalyst sample was tested three times with 15-30 minutes between tests for catalyst recovery in air. The data was down loaded from CO analyzer and the % CO conversion for each catalyst was calculated and compared. FIG. 7 shows the average % CO conversion from the three test runs.

% CO conversion of different particle sizes as well as % palladium metal loading were measured. CO removal catalyst 801 had 1.04% Pd metal loading on a starting substrate particle size of 9.8 micron (Grace C809). CO removal catalyst 802 had 0.63% Pd metal loading on a starting substrate particle size of 1-2 mm. CO removal catalyst 803 is identical to catalyst 802, except, it is ground into ˜1 to ˜500 microns. For this comparative testing, 1 gram of each catalyst was preconditioned at 50±5% RH and 23±3C inside a 10 L chamber for 2 days. Each chamber contained a micro fan for circulating the inside air, a Drager Pac III CO analyzer for logging the remaining CO. At the end of the preconditioning period, 31 cc of 5% CO in air was injected into the chamber to create 150 ppm CO. The chamber was vented at the end of 30 minutes. Each catalyst was tested 3 times with only 15-30 minutes of recovery time between tests. The average of 3 test runs are then compared. Due to its high surface area and high % of palladium loading catalyst 801 was expected to be the best performer. A surprised outcome was observed instead where catalyst 802 with both lower surface area and lower palladium loading of only 0.63% actually performed better than catalyst 801. As expected, catalyst 802 performs better than catalyst 803 even though they both have the same palladium loading, because catalyst 802 has significantly higher surface area than does catalyst 803 as a result of grinding.

The performance of catalyst 802 was measured at 30±2% relative humidity and 23±3C 902A, 50±2% relative humidity and 23±3C 902B, and 80±2% relative humidity and 23±3C 902C. One gram of catalyst 802 was spread on a 96 mm ID petri dish and stored in a 10 L chamber at each % RH for 2 to 3 days. 31 cc of 5% CO was injected to create 150-ppm CO. A CO analyzer recorded the remaining CO concentration every minute. The catalyst was tested at each % RH 3 times with only 10-15 minutes of recovery time between tests. The average % CO conversion from three different 3 test runs was compared. Catalyst 802 has an average % CO conversion of 97% at 30% RH 902A, 91% at 50% RH 902B, and 94% at 80% RH 902C, respectively.

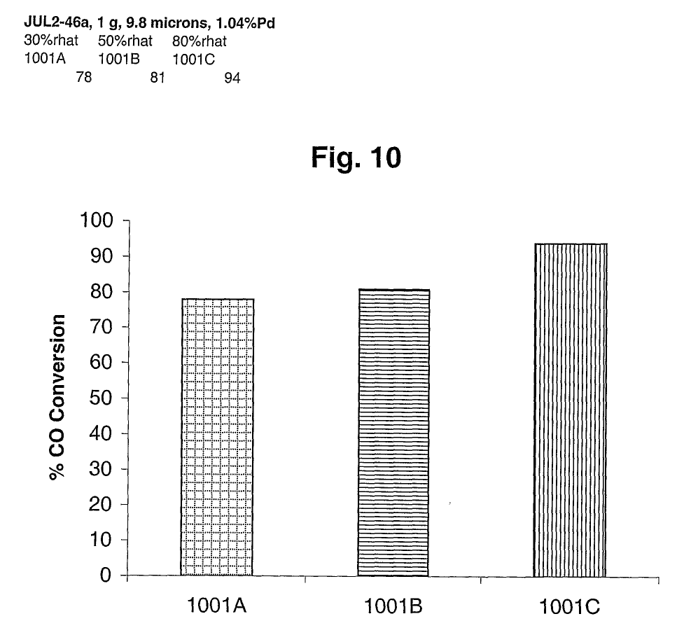

FIG. 10 is a bar graph showing the performance of catalyst 801 at 3012% relative humidity and 23±3C 1001A, 50±2% relative humidity and 23±3C 1001B, and 80±2% relative humidity and 23±3C 1001C. The catalyst 801 (FIG. 8) was prepared similar to example 22, except powder silica was used instead of silica beads and, therefore, no grinding was needed. Since powder silica (Grace C809, 8.4-9.8 microns) has higher surface area than silica beads (1.0-2.0 mm), more catalyst reagent 5PMA solution was needed to coat it such that the Pd loading was 1.04% instead of 0.63% like in the case of 801 and 802. One gram of catalyst 801 was spread on a 96 mm ID petri dish and stored in a 10 L chamber at each % RH for 2 to 3 days. 31 cc of 5% CO was injected to create 150-ppm CO in air. A CO analyzer recorded the remaining CO concentration every minute. The catalyst was tested at each % REI 3 times with only 10-15 minutes of recovery time between tests. The average % CO conversion from three different test runs is plotted. Catalyst 801 has an average % CO conversion of 78% at 30% RH 1001A, 91% at 81% RH 1001B, and 94% at 80% RH 1001C, respectively. Even with higher surface area (8.4-9.8 microns, Grace C809) and higher Pd loading of 1.04%, catalyst 801 is inferior in performance when compared to catalyst 802.

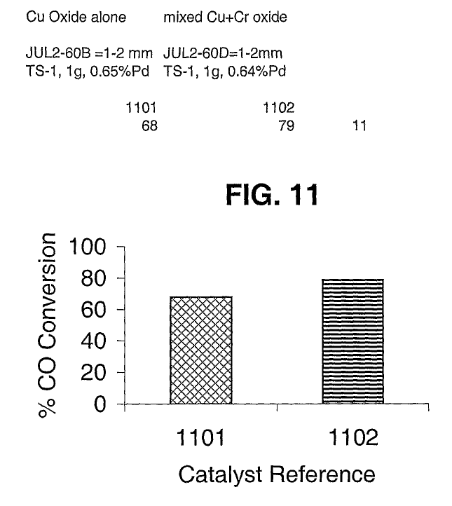

FIG. 11 is a bar graph showing the performance of two catalysts: one had a copper oxide on silica bead as starting substrates 1101 and the other had mixed copper and chromium oxides, also on silica bead as starting substrates 1102. Both were coated with catalyst reagent 5PMA. Both had the same Pd loading of 0.64% and both had the same surface area. Catalyst 1101 was made according to example 23 and catalyst 1102 was made according to example 22. In order to avoid variation in particle sizes neither catalyst was ground prior to test. One gram each was spread on a 96 mm ID petri dish and stored in a 10 L chamber at each 50±5% RH and 23±3C for 2 to 3 days. 31 cc of 5% CO was injected to create 150-ppm CO in air inside the 10 L chamber. A CO analyzer recorded the remaining CO concentration every minute. Each catalyst was tested 3 times with only 15-30 minutes of recovery time between tests. The average % CO conversion from three different test runs is plotted and compared. Catalyst with copper oxide alone has an average % CO conversion of 68% 1101, compared to 79% for catalyst with both copper and chromium oxides 1102. The addition of chromium oxide has increased the efficiency of Pd by 16%.

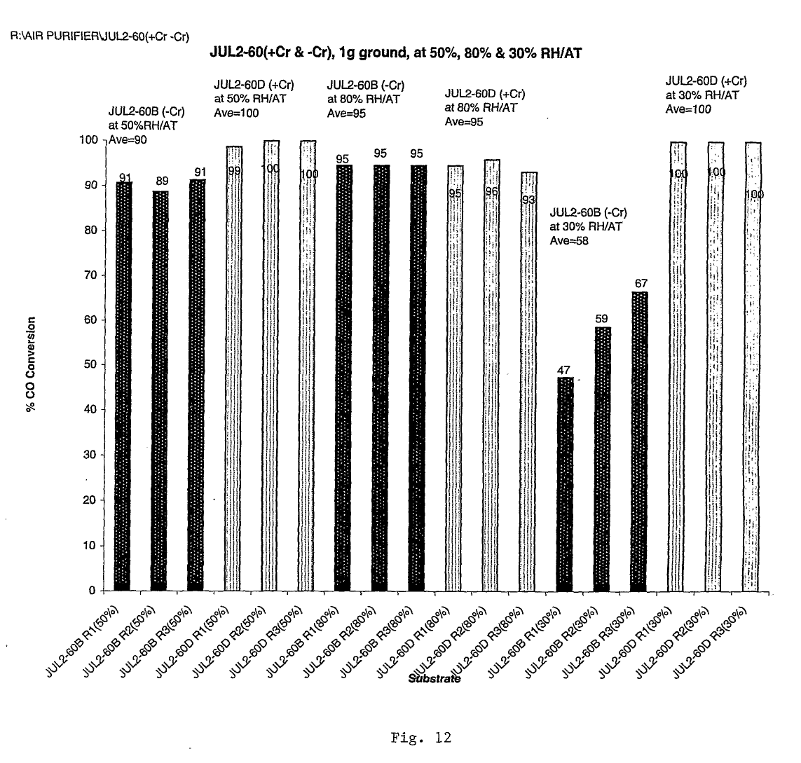

FIG. 12 is a bar graph showing the performance of two catalysts: one had a copper oxide on silica bead as starting substrates 1101 (FIG. 11) and the other had mixed copper and chromium oxides, also on silica bead as starting substrates 1102 (FIG. 11). Both were coated with catalyst reagent 5PMA. Both had the same Pd loading of 0.64% and both had the same surface area. These were the same two catalysts from FIG. 11, but were now “ground” then tested at 30±3% RH/23±3C, 50±3% RH/23±3C, and 80±3% RH/23±3C. One gram each was spread on a 96 mm ID petri dish and stored in a 10 L chamber at each test condition for 2 to 3 days. 31 cc of 5% CO was injected to create 150-ppm CO in air inside the 10 L chamber. A CO analyzer recorded the remaining CO concentration every minute. Each catalyst was tested 3 times at each test condition, with only 15-30 minutes of recovery time between tests. The average % CO conversion from three different test runs is plotted and compared. Catalyst made with copper oxide alone had an average % CO conversion of 58% 1201A, 90% 1201B, and 95% 1201C, compared to 100% 1202A, 100% 1202B, and 95% 1202C for the catalyst made with both copper and chromium oxides, when tested at 30±3% RH/23±3C, 50±3% RH/23±3C, and 80±3% RH/23±3C, respectively. It appears that the chromium oxide provides a better hydrogen-bonding network at lower relative humidity test condition than the does the copper oxide.

### Table 1

Summary of CO oxidation performance of the same groups of catalysts in two different types of CO gas mixtures is shown in Table 1. CO oxidation in nitrogen is different from CO oxidation in simulated reformate gas mixture. There is no correlation between the two sets of results. Catalysts were subjected to 0.2% CO in nitrogen versus 0.2% CO in 40% N₂, 45% H₂, and 14.8% CO₂ at 65-70° C. Standard compressed air was used to regenerate the catalysts. Both CO containing gas and air was humidified so that the relative humidity of the CO test gas and air was controlled to within ˜40 to 60% relative humidity for both air and CO gas feed. The volumetric space velocities for both the CO gas mixture and air were 3,500 Hr-1 with the cycle of 5 minutes in CO and 5 minutes in air.

Duration (Hr.) Outlet CO < 20 PPM when tested in

| | | 0.2%CO 45%H₂, |
|---|---|---|
| Catalyst | 0.2% in N₂ | 14.8%CO₂, 40%N₂ |
| 5Y | 1.0 | <0.5 |
| P-150C | 0.2 | 3.3 |
| P-22C | 2.0 | 5.76 |
| P-88H | 3.0 | 4.8 |

### Table 2

Summary oxidation performance of catalysts 88H, 106A, and 106B is shown in Table 2. Catalysts were subjected to 0.2% CO in 40% N₂, 45% H₂, and 14.8% CO₂ at 65-70° C. Standard compressed air was used to regenerate the catalysts. Both CO containing gas and air was humidified so that the relative humidity of the CO test gas and air was controlled to within 40 to 60% relative humidity for both air and CO gas feed. The volumetric space velocities for both the CO gas mixture and air were 3,500 Hr-1 with the cycle of 5 minutes in CO and 5 minutes in air.

| | Duration (Hr.) with | Duration (Hr.) with |
|---|---|---|
| Catalyst | Outlet CO <20 PPM | Outlet CO <10 PPM |
| P-88H | 4.75 | 0.75 |
| P-106B | 6.0 | 5.00 |
| P-106A | 6+ | 6+ |

### Table 3

Summary of CO oxidation performance of catalysts 140C and 22C at 24C, 55C, and 70C is shown in Table 3. Table 3 shows the outlet CO at each temperature after 1 hour of testing at that temperature. Catalysts were subjected to 0.2% CO in 40% N₂, 45% H₂, and 14.8% CO₂ at 65-70° C. Standard compressed air was used to regenerate the catalysts. Both CO containing gas and air was humidified so that the relative humidity of the CO test gas and air was controlled to within ˜40 to 60% relative humidity for both air and CO gas feed. The volumetric space velocities for both the CO gas mixture and air were 3,500 Hr-1 with the cycle of 5 minutes in CO and 5 minutes in air. CO oxidation performance is better at lower temperature.

| Catalyst | 24° C. | 55° C. | 70° C. |
|---|---|---|---|
| P-140C | 11 | 16 | 297 |
| P-22C | 12 | 8 | 32 |

### Table 4

CO oxidization as function of relative humidity of the feed CO and air is shown in Table 4. The table summarizes % relative humidity versus outlet CO concentrations in simulated reformate at 70° C. Catalyst performance is proportional to relative humidity. Catalysts were subjected to 0.2% CO in 40% N2, 45% H₂, and 14.8% CO₂ at 65-70° C. Standard compressed air was used to regenerate the catalysts. Both CO containing gas and air was humidified so that the relative humidity of the CO test gas and air was controlled to within ˜40 to 60% relative humidity for both air and CO gas feed. The volumetric space velocities for both the CO gas mixture and air were 3,500 Hr-1 with the cycle of 5 minutes in CO and 5 minutes in air. CO oxidation performance is better at lower temperature. It was observed that as the relative humidity of the CO gas mixture and air decreased because the water inside the humidifier (bubbler) was decreasing, the CO oxidation activity also decreased. CO oxidization efficiency increased when the bubbler was refilled and the relative humidity of the CO gas mixture and air increased. In actual fuel cell applications, it is expected that the CO oxidation performance will either stabilize at a normal level (as determined during tests) or improve because reformate stream contains 5-10% H₂O.

| % RH: | 58-62% RH | 45-50% RH | 56-57% RH |
|---|---|---|---|
| Outlet CO (PPM): | 6-8 | 22-31 | 12 to 13 |
| Elapsed Time (Hr.): | 3.0-4.0 | 8.5-9.0 | 10.5-11.5 |

### Table 5

Selectivity of the new catalyst series at 24° C., 55° C., and 70° C. are summarized in Table 5. % H₂ in the outlet reformate was 45.09% at 24° C., 45.10% at 55° C., and 45.09% at 70° C. respectively, compared to 45.11% in the inlet reformate. The difference in the H₂ concentrations between the inlet and the outlet reformate is well within the +/−0.5% tolerance of the ThermoElectron Process Mass Spectrometer. Therefore, no H₂ loss was detected during CO oxidization at from 24 to 70° C.

| Temperature: | 24° C. | 55° C. | 70° C. |
|---|---|---|---|
| Inlet % H₂ | 45% | 45% | 45% |
| Outlet % H₂ | 45% | 45% | 45% |

The present invention is also useful in the 99% removal of 50 to 200 ppm CO from air, which human breaths. This is extremely important for removing toxic levels of CO from air in homes, automobiles, aircrafts, and commercial buildings. The present invention involves a series of Pd, Mo, Mn, Ca, V, Cr, Na and Cu based catalysts, which can convert 90-99% of 150 ppm CO within 30 minutes in a 10 L chamber. Experimental data, which verifies these statements, are shown in Tables below.

### Table 6

Summary of % CO conversion inside a 10 L test chamber with and without CO catalyst present is shown in Table 6 below. The catalyst P-106A was prepared according to example 17, preferred embodiment 2. The test was conducted at standard laboratory room temperature and pressure with relative humidity maintained within 30 to 80%. 3 grams of catalyst 106A catalyst was placed on a 11″ diameter petri dish inside a 10 L chamber, containing a Drager Pac III CO analyzer/data logger for reading the remaining CO concentration in the chamber. For the test with the without the CO catalyst, 3 grams of blank silica gel replaced the 3 grams of catalyst. A graphical presentation of this Table is shown in FIG. 1. Within 30 minutes, 3 grams of catalyst 106A was able to reduce the CO concentration by 82%, compared to “without catalyst,” only 1% of CO was reduced, perhaps due to leakage but not CO oxidation reaction.

% CO Conversion

| Elapsed Time, Min. | With Catalyst 106A | Without Catalyst |
|---|---|---|
| 0 | 0 | 0 |
| 10 | 42 | 1 |
| 20 | 67 | 1 |
| 30 | 82 | 1 |
| 40 | 90 | 1 |
| 50 | 95 | 2 |
| 60 | 100 | 2 |

### Table 7

Performance comparison between the old catalysts (10K, 5Y) and new catalysts (P-106A, P-95B, and P-46B) in their ability to remove CO (in air) within 30 minutes is shown in Table 7. Each catalyst was tested inside a 10 L chamber. The test was conducted at standard temperature and pressure with relative humidity range from ˜30 to 80%. 3 grams of each catalyst (1.0-2.0 mm diameter porous silica spheres) was spread on a 96 mm diameter petri dish inside a 10 L chamber, containing a Drager Pac III CO analyzer/data logger for recording the CO concentration in the chamber. 31 cc of 5% CO balance air was injected to create 150-ppm inside the 10 L chamber. The CO analyzer automatically logged the CO concentration. Each test was concluded at the end of 30 minutes. The results indicate that the new P catalyst series performed better than the old catalysts when remove CO in air for air purification application.

| Old and New | % CO Conversion |
|---|---|
| Catalysts | at 30 minutes |
| 10K | 27 |
| 5Y | 55 |
| P-106A | 82 |
| P-95b | 97 |
| P-46b | 100 |

It has been observed that increasing surface area and reducing diffusion distance can increase catalyst activity by 3 folds. Increasing surface area and decreasing diffusion distance can be achieved by grinding the 1.0-2.0 mm beads to 10-100 microns “prior” to CO removal testing. For example, it has been consistently measured that a 1-gram of “ground” catalyst performs as well as a 3-grams of 1.0-2.0 mm catalyst beads. Experimental data, which verifies these statements, is shown in Table 8.

Table 8 (Also shown in FIG. 7)

Performance comparison between ground catalyst and un-ground catalyst 95B series in their ability to remove CO within 30 minutes is shown in Table 8. Each catalyst was tested inside the 10 L chamber. These catalysts were prepared according examples 19 and 20. The test was conducted at standard temperature and pressure with relative humidity range from ˜30 to 80%. Note that it took only 1 gram of ground instead of 3 grams un-ground to achieve 95% CO conversion. Each catalyst sample was spread on a 96 mm diameter petri dish inside a 10 L chamber, containing a Drager Pac III CO analyzer/data logger for recording the CO concentration in the chamber. 30 cc of 5% CO balance air was injected to create 150-ppm inside the 10 L chamber. The CO analyzer automatically logged the CO concentration. Each test was concluded once 30 minutes had elapsed. The results indicate that more over 50% of the catalysts tested, were able to convert 90 to 95% of the 150-ppm CO to CO₂ within 30 minutes. A graphical presentation of this Table is shown in FIG. 7.

| Elapsed Time | 95B catalyst, 1 g, | 95B catalyst, 3 g, |
|---|---|---|
| (min.) | ground, example 20 | 1-2 mm beads, example 19 |
| 2 | 0 | 0 |
| 5 | 23 | 23 |
| 10 | 53 | 55 |
| 15 | 72 | 74 |
| 20 | 84 | 85 |
| 25 | 91 | 92 |
| 30 | 95 | 95 |

In addition, it has also observed that CO oxidation performance is not necessary proportional to the Pd loading. It appears that certain surface and structural properties of certain silica substrates play a major role in the molecular layering and distribution of the catalyst reagent, which contains Pd. For example, substrate TS-1 from ChemSource West, (ground after Pd coating from the original 1-2 mm porous silica beads down to 1 to 500 micrometers) had the lowest Pd loading among all 16 substrates tests, yet outperformed all those with much higher Pd loadings. The results, which led to this observation is shown in Table 9.

### Table 9

Performance of 16 different silica based substrate supports, which were subjected to the same fabrication treatment including: 1) the same one mixed copper and chromium oxides, 2) the same catalyst reagent “5PMA”, 3) the same test conditions. In order words, each catalyst was fabricated according to example 22. Due to the variation in particle sizes, porosity, pore volume, and surface area, some catalysts ended up with more Pd loading than others. 15 out of 16 stared off as powder silica with particle sizes ranging from 8.4 micrometers (Grace C809) to 60 micrometer (PPG Lo-Vel, sample# 2476). For this reason, ChemSource Inc.'s substrate (TS-1), which started off with 1.0-2.0 particle size had to be coarsely ground. prior to test. One gram each was spread on a 96 mm ID petri dish and stored in a 10 L chamber at 50±5% RH/23±3C for 2 days. 31 cc of 5% CO was injected to create 150-ppm CO in air inside the 10 L chamber. A CO analyzer recorded the remaining CO concentration every minute. Each catalyst was tested 3 times, with only 15-30 minutes of recovery time between tests. The average % CO conversion from three different test runs is summarized in Table 9 below.

| | Substrate | | % CO | % Pd | Particle size |
|---|---|---|---|---|---|
| Reference | Support | Supplier | Conversion | Loading | (micrometer) |
| JUL2-29A | Davisil 640 | Grace DC | 90 | 2.16 | 18 |
| JUL2-29B | Vydac 101 MFG | Grace DC | 78 | 1.58 | 10 to 25 |
| JUL2-29C | Exsil 80A | Grace Alltech | 82 | 1.26 | 10 |
| JUL2-29D | Exsil 100A | Grace Alltech | 87 | 1.28 | 10 |
| JUL2-29E | Grace C809 | Grace | 97 | 1.94 | 8.4-9.6 |
| JUL2-29F | Grace C809 | Grace | 94 | 2.41 | 9 |
| JUL2-34A | BriteSorb D350 | PQ Corp. | 84 | 1.18 | 30-50 |
| JUL2-34B | BriteSorb C935 | PQ Corp. | 54 | 1.13 | 30-50 |
| JUL2-68A | Sunsphere H-122 | Asahi Glass | 92 | 1.3 | 10.5~13.5 |
| | | Japan | | | |
| JUL2-68B | PPG Lo-Vel 6000- | PPG Industries | 90 | 1.22 | 11 |
| | 2477 | | | | |
| JUL2-68C | PPG Lo-Vel 4000- | PPG Industries | 91 | 1.06 | 10 |
| | 2478 | | | | |
| JUL2-68D | PPG Lo-Vel 2000- | PPG Industries | 87 | 1.28 | 13 |
| | 2480 | | | | |
| JUL2-68E | PPG Lo- | PPG Industries | 92 | 1.4 | 60 |
| | Vel, sample# 2476 | | | | |
| JUL2-68F | PPG Lo-Vel, | PPG Industries | 83 | 1.59 | 60 |
| | sample# 2479 | | | | |
| JUL2-68G | Sunsphere L-121 | Asahi Glass | 90 | 0.89 | 10.5~13.5 |
| | | Japan | | | |
| JUL2-60D | ChemSource West | TS-1, 1-2 mm, | 100 | 0.64 | ground prior to |
| | | | | | CO test |

Examples 1 through 23 above illustrate a method to coat porous silica with a catalytic reagent mixture that will convert CO to CO₂ at low temperature. This novel reagent mixture includes both organic and inorganic reagents, all of which are listed in-groups 1 through 8 above and the substrates, which have been described above as Substrates 1 to 11. Substrate 9 is porous silica and in the exemplary embodiment, it is first coated with copper hydroxide, copper oxide, iron hydroxide, or iron oxide, cerium oxide, chromium oxide, samarium oxide, or mixtures thereof as it is made by impregnation with cupric or cuprous nitrate, ferrous or ferric nitrate, and fire at 400-500° C. for a specified period of time.

Other mixed metal oxides coated on the silica to enhance the CO to CO₂ conversion include yttrium oxide, cerium oxide, and complex copper, iron, manganese and cobalt oxides.

Another important method to produce porous metal oxide coatings is to first prepare an organometallic precursor as described in U.S. Pat. No. 5,662,737 and is herein incorporated by reference. The following is a modification of the above patented process. Add 600 g of 0.5 molar solution copper, manganese and cobalt in isopropanol or similar alkoxide under dry nitrogen; add drop wise a solution containing 40 grams of 2-ethylhexanic acid in 250 ml of isopropanol. After the reaction became milky a solution containing 95 grams of isopropanol and 5 grains water. Reflux for 2.5 hours at 70° C. Cool to 0° C. with ice. Then remove at all solvent at room temperature by vacuum evaporation, which leave the solid acid metal compound. A non-polar solvent (such as cyclohexane) is mixed with the powder to form a solution. A thin high-surface area metal oxide can be formed by dip coating in air and drying followed by heating to above 500° C. for a few hours to over 40 hours. The surface area and thickness of the high surface area metal oxide depends on the amount of solvent and its viscosity. The firing temperature and ramp will determine some of the properties of the coating.

A method for making porous silica based substrates and monolithic structures for coatings use TMOS=Si(OCH₃)₄ and/or TEOS=Si(OCH₂CH₃)₄.

nSi(OR)₄+4n water=nSi(OH)₄+4n ROH where R is either methyl or ethyl groups. An acid or base catalyst may be used to increase the rate of reaction. Raising the temperature to 65 C increase the rate and leads to bulk densities of about 1.0 to 1.2 g per cubic cm. HCl catalyst results in a clear gel with porous sizes about 10 to 25 angstroms. The 25 use of basic catalyst, such an ammonium hydroxide, shrinks less than acid catalyst: however, in a thin coating shrinkage is less of a problem.

The porous metal oxide may range from 1 to 30 microns in size. After drying these oxide and hydroxide, they should generally be fired to over 400° C. and sometimes to 900° C. depending on the material.

Those skilled in the art would readily appreciate that the scope of the invention is not limited to the presently described embodiments. For example, any number of properties of the catalyst is measured such as, for example, reflection of light from the surface as a means to eliminate one or more CO sensors. One skilled in the art would appreciate an apparatus and method for catalyzing CO to CO₂ for any application where CO is not preferred over CO₂. Many other modifications and variations will be apparent to those skilled in the art, and it is therefore, to be understood that within the scope of the appended claims the invention may be practiced otherwise than as specifically described.

What is claimed is:

1. An air purification device comprising a control circuit for adjusting blower (fan) speed and controlling power on and off, a means to filter the air contained within the device housing an AC power cord to bring power into the motor and a fan or blower to move the air from the outside of the air purifier apparatus to the filter and an additional catalyst system that comprises the following major components a housing that holds the catalyst and sandwiched between two getter components, the getter may comprise a highly porous activated carbon which can be impregnated with an acid and the CO removal catalyst comprise the following
Substrate 1: porous silica beads with bead sizes ranging from 1-5 millimeter, pore sizes range from 100-150A, surface area of 250-450 m2/gram, and pore volume range 0.9-1.1 cc/g; and is coated with 0.5 molar to 1.5 molar copper nitrate and/or 0.01-0.38 M nitrate salt of Cr, Co, Pr, Sm, Sc, Y, Tm, Zn, Yb, Ni, Nd, Ho, Ce, Dy, Gd, La, Er, Sn, Zn, and/or any mixture thereof and fired at 350-500° C., and then further coated with a catalyst reagent containing least one chemical from the following groups: Group 1: Palladium salts selected from the group consisting of PdBr₂, PdC₁₂, CaPdC₁₄, CaPdBr₄, Na₂PdCl₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄, meta-sodium vanadate (NaVO₃, lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; Group 8: Strong oxidizer such as peroxide.

2. A method for preparing a catalysts that oxidizes CO to CO₂ in air and/or hydrogen gas streams, and/or in any enclosed and/or semi-enclosed enclosures of a working or transporting environment by exposing air to the catalyst system containing: a catalyst that is made from a high surface area porous silica substrate; and a process to coat that substrate with metal oxide(s); and a process to coat that oxides-coated substrate with a catalyst reagent that comprises a very thin layer of complex salts of copper, phosphorous, molybdenum, an alkali metal vanadate or mixture thereof, palladium and another salt selected from the Group comprising nickel, cadmium, iron, zinc, magnesium, manganese, cobalt, chromium, or calcium and/or mixtures thereof and further comprising a host guest organic material selected from the group of cyclodextrins and their derivatives and further the coating with the catalytic process involve dissolving the constituents into a solution adding the solution to the silica coated with a metal oxide such as copper, rare earth oxide, iron oxide or mixtures thereof.

3. An apparatus for reducing CO concentration in an enclosed space such as a room within any residential or commercial building; comprising a tubular shaped housing, an electric motor, fan blade to pull in the contaminated air, and two getters systems located on either side of the CO removal catalyst, a means to power the motor; where the getter system comprised a felt coated with Polyvinyl Methyl Acrylic Acid (PVMA) or other acids, porous carbon coated with an acid such as H₃PO₄ or other acids, a porous activated carbon, a pre-filter, a HEPA filter, a carbon filter, furthermore a CO removal catalyst comprising at least a Substrate 1: porous silica beads with bead sizes ranging from 1-5 millimeter, pore sizes range from 100-150 A, surface area of 250-450 m2/gram, and pore volume range 0.9-1.1 cc/g; and is coated with 0.5 molar to 1.5 molar copper nitrate and/or 0.01-0.38 M nitrate salt of Cr, Co, Pr, Sm, Sc, Y, Tm, Zn, Yb, Ni, Nd, Ho, Ce, Dy, Gd, La, Er, Sn, Zn, and/or any mixture thereof and fired at 350-500° C., and then further coated with a catalyst reagent containing least one chemical from the following groups: Group 1: Palladium salts selected from the group consisting of PdBr₂, PdC₁₂, CaPdC₁₄, CaPdBr₄, Na₂PdC₁₄, Na₂PdBr₄, K₂PdCl₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; Group 8: Strong oxidizer such as peroxide.

4. An apparatus as claimed in claim 3 comprising a high surface area, porous silica substrate with least 300 m2/gram and at least 100 Angstrom pore size, that is coated with oxides and further comprising a very thin layer of catalyst reagent containing at least one chemical selected from each of the following groups 1 through 8: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄, meta-sodium vanadate (NaVO₃, lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof, Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide.

5. An apparatus as claimed in claim 3 comprising chemistry listed in groups 1 to through 6 and/or groups 1 though 8 with the following ratios:
Group 1 Group 2 = 2.47:1 to 3.71:1
Group 3 Group 2 = 6.19:1 to 18.56:1
Group 4 Group 2 = 0.09:1 to 0.28:1
Group 5 Group 2 = 2.78:1 to 8.33:1
Group 6 Group 2 = 0.003:1 to 0.008:1
And/or
Group 1 Group 2 = 1.78:1 to 8.00:1
Group 3 Group 2 = 3.86:1 to 17.38:1
Group 4 Group 2 = 0.02:1 to 0.58:1
Group 5 Group 2 = 3.98:1 to 17.99:1
Group 6 Group 2 = 0.01:1 to 0.02:1
group 7 group 2 = 0.10:1 to 3.00:1
group 8 group 2 = 0.10:1 to 3.00:1

6. An apparatus as claimed in claim 3 for removing CO from a hydrogen containing gas stream and/or air below 130° C.; and further comprising a method to pre-coat the substrate with copper nitrate solution from 0.1 molar to 3 molar and/or mixed with 0.01 molar to 0.4 molar of nitrate salt of Cr, Co, Pr, Sm, Sc, Y, Tm, Zn, Yb, Ni, Nd, Ho, Ce, Dy, Gd, La, Er, , Sn, Zn, and/or any mixture thereof, then evaporating the excess liquid water and then firing at 350-500° C. such that the silica substrate is coated with copper oxide, copper hydroxide or a mixture thereof, copper oxide plus another oxide of Cr, Pr, Co, Sm, and any mixture thereof, follow by the catalyst reagent coating.

7. An apparatus as claimed in claim 2 comprising a means to detect CO where the CO detector is located on the front such that it can be seem easily to alert the end user when the CO removal catalyst needs to be replaced.

8. An apparatus for reducing CO concentrations and a means for alerting the end user of CO levels and the time to change the CO catalyst in an enclosed space such a room within any residential or commercial building, comprising CO removal catalyst made up of components selected at least one each form the following 9 groups: Group 1: Palladium salts selected from the group consisting of PdBr₂, PdC₁₂, CaPdC₁₄, CaPdBr₄, Na₂PdC₁₄, Na₂PdBr₄, K₂PdCl₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide, Group 9: porous silica substrates, and further comprising a coating of copper oxide and/or mixed oxides of copper and Cr, Sm, Co, Ho, Pr or any mixture thereof.

9. An apparatus, as claimed in claim 6 comprising a CATALYST made of a porous substrate such as aluminum oxide, porous silica material, or other metals or mixed metal oxides including silica coated with those of copper, Cr, Co, Sm, Pr, Nb, or iron and/or any combination thereof, which is then further coated with a catalyst reagent comprising at least one each of the following groups 1 to 6 and/or groups 1 to 8: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide.

10. An apparatus as claimed in claim 3 for removing CO from the air intake of a fuel cell and/or air purifier comprising a means to catalytically convert CO to CO₂ at temperatures below 80° C. and over a wide range of relative humidity.

11. An apparatus a claimed in claim 3 further comprising a catalyst consisting of at least one of the following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide.

12. An apparatus as claimed in claim 10 comprising a means for measuring and controlling CO levels in an air stream before it enters a proton exchange membrane air side of the fuel cell; and further comprising a means to sense the CO in air, which is above a predetermined level; and further comprising a porous silica material coated with copper oxide and/or hydroxide or iron oxide or hydroxide and/or mixtures thereof, and further comprising a chemical reagent made up of at least one of the following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide.

13. An apparatus as claimed in claim 10 comprising a catalyst made from a supramolecular complex; and the complex catalyst coating is self-assembled on to a semi-transparent silica porous substrate; and further comprising a thin layer on the porous transparent substrate, which is made by adding soluble compounds comprising palladium, copper, molybdenum and at least one of the following as calcium, magnesium, manganese, cadmium, nickel, cobalt, chromium, nickel, iron, zinc, with halogen anions, an acid, and a strong peroxide oxidizer.

14. A method as claimed in claim 2 for converting CO to CO₂ comprising a catalyst in the air stream to control the CO below 20 ppm; and further comprising a CO 75 sensor to monitor the catalyst by responding to the some predetermined CO concentrations in the air to alert the end user to either evacuate the enclosed space and/or to change out the CO removal catalyst.

15. A method for reducing the concentration and removing a portion of CO from the fuel cell air intake and/or from an enclosed space and further comprising a thin semi-transparent sensing layer on the porous substrate comprising palladium, copper and calcium metals ions, halogen anions, cyclodextrins and their derivatives, an acid, and an oxidizer, and mixtures thereof.

16. An apparatus for removing CO from a reformer gas stream and/or from air in an enclosed space comprising a means to measure the CO concentration and further comprising catalyst formulations coated onto a silicon oxide substrate that may also be coated with metal oxides such as copper, Cr, Sm, Pr, Co, or iron oxides/hydroxide and/or mixtures thereof, which further comprises at least one catalyst reagent selected from following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide, within ranges of the following mole ratios selected from Groups 1 to 6: Group 1 to Group 2=2.47:1 to 3.71:1, Group 3 to Group 2=6.19:1 to 18.56:1, Group 4 to Group 2=0.09:1 to 0.028:1, Group 5 to Group 2=2.78:1 to 8.33:1, and Group 6 to Group 2=0.003:1 to 0.008:1, and/or furthermore those catalyst reagents comprising Groups 1 to 9 within the mole ratios of Group 1 to Group 2=1.78:1 to 8.00:1, Group 3 to Group 2=3.86:1 to 17.38:1, Group 4 to Group 2=0.02:1 to 0.58:1, Group 5 to Group 2=3.98:1 to 17.99:1, Group 6 to Group 2=0.01:1 to 0.02″1. Group 7 to Group 2=0.10:1 to 3.00:1, and Group 8 to Group 2=0.10:1 to 3.00:1.

17. A method as claimed in claim 14 comprising a process to remove CO in the air for the fuel cell anode and for breathing, comprise CO catalyst reagents, which the copper is from 0.85 to 15 times the palladium concentration; further comprises a slow dry method of fabrication for allowing the substrate to form the supramolecular catalyst, and further the catalyst is placed between two porous materials capable of removing basic gases.

18. A method as claimed in claim 15 where the process of cleaning the air first involves removing the ammonia and other basic gases and particulate matter by passing the gas stream through a filter material such as porous silica, porous carbon beads, or polyester felt, which is impregnated with an acid such as phosphoric acid, citric acid, and free acid copolymer of methyl and vinyl ether malaic anhydride.

19. A method as claimed in claim 16 further comprising a means of 1 CO measurement, at which the sensor responds to CO increase in the surrounding environment of L 5 an enclosed space and/or semi-enclosed space such as a room within a home or a building; and further comprising at least one optically responding sensor, that can be monitored by a low-powered electronic circuit with a current draw of less than 25 milli-amps to output signals to alert the end user the CO concentration is approaching a dangerous level and that one must evacuate and replace the CO removal catalyst; and further comprises an active sensor comprising a supramolecular complex that is self-assembled on to a porous transparent silica substrate; and further comprising a sensing layer on a porous transparent substrate comprising ions of palladium, molybdenum such as silicomolybdic acid, copper, calcium, chloride, bromide, and cyclodextrins and their derivatives and an acid.

20. A method as claimed in claim 17 for measuring the CO concentration in the air of an enclosed space and further comprising a means to control the CO below a predetermined level, comprising a method of manufacturing the sensor and CO removal catalyst by coating porous silica substrates coated with copper oxide, chromium oxide, samarium oxide, praseodymium oxide, cerium oxide, cobalt oxide, or iron oxide, or any mixture thereof, which is further coated with a chemical mixture comprising at least one chemical selected from the following groups,: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; and Group 8: Strong oxidizer such as peroxide; and after the coating of the silicon dioxide substrate for a period of time ranging from 0.1 hours to 100 hours the CO removal catalyst and sensing elements are dried slowly under a wide range of temperature ranging from 20° C. to 80° C. for a period of time ranging from 0.1 hours to 100 hours to form the supramolecular sensing complex of the surface of the substrate; wherein the copper content is 0.85 to 15 times the palladium concentration.

21. An apparatus for reducing CO concentration in an enclosed space comprising a catalyst with at least one of the following ingredients: porous silica coated with copper oxide, praseodymium oxide, chromium oxide, or any mixture thereof, beta and gamma cyclodextrins as well as derivatives thereof or and/or mixture thereof and copper and palladium chloride ions as well as compounds containing molydosilicic acid, phosphomolybdic acid, or mixture of both and a metal chloride and bromide such as cadmium, zinc, calcium or magnesium.

22. An apparatus for removing CO from the air in a room, building or other enclosed or partially enclosed structure further an enclosure for the catalyst that has openings to allow air and CO entry and a means to remove CO₂ and further comprising a means to extend the life of the catalyst by removing certain contaminates from the air entry points before they reach the catalyst bed and further comprising within the enclosure are many highly porous silica coated particles which are first coated with coated with 0.5 molar to 1.5 molar copper nitrate and/or 0.01-0.38 M nitrate salt of Cr, Co, Pr, Sm, Sc, Y, Tm, Zn, Yb, Ni, Nd, Ho, Ce, Dy, Gd, La, Er, Sn, Zn, and/or any mixture thereof and fired at 350-500° C., and then further coated with a catalyst reagent containing least one chemical from the following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; Group 8: Strong oxidizer such as peroxide.

23. A claim as in claim 20 further comprising a means to move air from prefilter, to the activated carbon coated with an acid, to the HEPA filter, then through the CO removal catalyst.

24. A claim as in claim 21 further comprising a microprocessor and software to control the CO removal system and air movement speed and to alert user to the need to replace the filter the CO removal catalyst system.

25. A claim as made in 22 further comprising an activated carbon material containing in part some acid, place on the air inlet and some on the air outlet side (on either side of the catalyst bed) to remove ammonia and VOC from the air before they can damage the catalyst.

26. A claim as in claim 23 and further comprising a CO removal device comprising a CO sensor, a display and alarm to warn of CO danger and indicate need of service, and a means to control the CO and other pollutants such as ammonia.

27. An apparatus for reducing CO concentration in semi-enclosed environment comprising at least catalyst held between two layers of getter in which CO is removed by catalytic oxidation and the force to move CO to the catalyst from other area in the environment is powered by the diffusion gradient for CO as it is converted to CO₂ in the catalyst and diffuse outward powered by another diffusion gradient; and further comprising a catalyst with at least one of the following ingredients: beta and gamma cyclodextrins as well as their derivatives and mixtures thereof, and copper, chromium, zinc, palladium chloride, and bromide ions as well as molydosilicic acid and inorganic acid and peroxide.

28. An apparatus to remove CO from the air in an enclosed structure further an enclosure for the catalyst that has openings to allow air and CO entry and also provides a means to remove CO₂ and further comprising a means to extend the life of the catalyst by removing certain contaminates from the air entry points before they reach the catalyst bed such as basic gases by providing a high surface area acid media and further comprising within the enclosure are many highly porous silica coated particles which are first coated with mixed oxide one or more selected from the group comprising copper, holmium, Nd, Sm, Pr, Mn and chromium oxide on the surface of the porous silica and then coated with catalyst reagent comprises at least one chemical reagent selected from the following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄), meta-sodium vanadate (NaVO₃), lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof., Group 6: Organic solvent and/or co-solvent trichloroacetic acid and any mixture thereof; Group 7: Soluble inorganic acids such as hydrochloric acid and nitric acid and any mixture thereof; Group 8: Strong oxidizer such as peroxide.

29. An apparatus for reducing CO concentration in an enclosed space such as a room within any residential or commercial building; comprising a rectangular shaped housing, an electric motor, squirrel cage blower to pull in the contaminated air through the pre-filters and HEPA filter, and then the air can b3e moved to the next stage, which comprises two getters systems located on either side of the CO removal catalyst, a means to power the motor and an electric motor; where the getter system comprised a felt coated with Polyvinyl Methyl Acrylic Acid (PVMA) or other acids, porous carbon coated with an acid such as H₃PO₄ or other acids, a porous activated carbon; and , a pre-filter, a HEPA filter, a carbon filter, furthermore the CO removal catalyst comprising at least a Substrate 1: porous silica beads with bead sizes ranging from 1-5 millimeter, pore sizes range from 100-150A, surface area of 250-450 m2/gram, and pore volume range 0.9-1.1 cc/g; and is coated with 0.5 molar to 1.5 molar copper nitrate and/or 0.01-0.38 M nitrate salt of Cr, Co, Pr, Sm, Sc, Y, Tm, Zn, Yb, Ni, Nd, Ho, Ce, Dy, Gd, La, Er, Sn, Zn, and/or any mixture thereof and fired at 350-500° C., and then further coated with a catalyst reagent containing least one chemical from the following groups: Group 1: Palladium salts selected from the group consisting of PdBr₂, PdC₁₂, CaPdC₁₄, CaPdBr₄, Na₂PdC₁₄, Na₂PdBr₄, K₂PdC₁₄, K₂PdBr₄, Na₂PdBr₄, CaPdClₓBr_{y}, K₂PdBr_{y}Clₓ, Na₂PdBr_{y}Clₓ (where x is 3 if y is 1), and mixtures thereof; Group 2: Molybdenum salts selected from the group consisting of silicomolybdic acid, phosphomolybdic acids, phosphotungstic acid, silicotungstic acid, ammonium molybdate, ortho-sodium vanadates (Na₃VO₄, meta-sodium vanadate (NaVO₃, lithium molybdate, sodium molybdate, cobalt molybdate, sodium tungstate, bismuth molybdate, and mixtures of any portion or all of the above; Group 3: Soluble salts of copper chloride and bromide and mixtures thereof, and smaller amounts copper organometallic compounds such as copper tetrafluoroacetic acid, copper trifluoroacetylacetonate, copper tungstate, and mixtures thereof; Group 4: Supramolecular complexing molecules selected from the cyclodextrin family including beta, gamma, as well as their soluble derivatives such as hydroxypropyl beta cyclodextrin and other derivatives and mixtures thereof; Group 5: Chloride and bromide salts of Al, Ca, Cd, Sr, Mg Ce, Co, Ir, Mn, Ni, Cr, Zn, Dy, Gd, Fe, Sm, and any mixtures thereof, Group 6: Organic solvent and/or co-solvent trichloroacetic acid and any mixture thereof; Group 7: Soluble inorganic acids such as hydrochloric acid and nitric acid and any mixture thereof; Group 8: Strong oxidizer such as peroxide.
